(19) United States
(12) Patent Application Publication
(10) Pub. No.: US 2019/0047893 A1
(43) Pub. Date: Feb. 14, 2019

(54) THERMALLY STRENGTHENED PHOTOCHROMIC GLASS AND RELATED SYSTEMS AND METHODS

(71) Applicant: CORNING INCORPORATED, Corning, NY (US)

(72) Inventors: Timothy Michael Gross, Corning, NY (US); Peter Joseph Lezzi, Corning, NY (US)

(21) Appl. No.: 16/073,614

(22) PCT Filed: Jan. 27, 2017
(86) PCT No.: PCT/US2017/015308

§ 371 Date: Jul. 27, 2018

Related U.S. Application Data
(60) Provisional application No. 62/288,549, filed on Jan. 29, 2016.

(51) Int. Cl. C03B 27/012; C03B 27/04; C03B 27/048; C03C 3/078; C03C 4/06

(52) U.S. Cl. CPC C03B 27/012; C03B 27/0413; C03C 4/06; C03C 3/078; C03B 27/048

(57) ABSTRACT

A strengthened photochromic glass sheet or article as well as processes and systems for making the strengthened photochromic glass sheet or article is provided. The process comprises heating the photochromic glass sheet to a desired temperature in a short time period without distortion to the photochromic glass sheet. The process also comprises in cooling the photochromic glass sheet by non-contact thermal conduction for sufficiently long to fix a surface compression and central tension of the sheet. The process results in thermally strengthened photochromic glass sheets.

This application claims the benefit of priority under 35 U.S.C. § 119 of U.S. Provisional Application Ser. No. 62/288,549 filed on Jan. 29, 2016, the content of which is relied upon and incorporated herein by reference in its entirety.

This application is related to and hereby incorporates herein by reference in full the following applications: Provisional Application Ser. No. 62/288,851, filed on Jan. 29, 2016, U.S. application Ser. No. 14/814,232, filed on Jul. 30, 2015; U.S. application Ser. No. 14/814,181, filed on Jul. 30, 2015; U.S. application Ser. No. 14/814,274, filed on Jul. 30, 2015; U.S. application Ser. No. 14/814,293, filed on Jul. 30, 2015; U.S. application Ser. No. 14/814,303, filed on Jul. 30, 2015; U.S. application Ser. No. 14/814,363, filed on Jul. 30, 2015; U.S. application Ser. No. 14/814,319, filed on Jul. 30, 2015; U.S. application Ser. No. 14/814,335, filed on Jul. 30, 2015; U.S. Provisional Application No. 62/031,856, filed Jul. 31, 2014; U.S. Provisional Application No. 62/074,838, filed Nov. 4, 2014; U.S. Provisional Application No. 62/031,856, filed Apr. 14, 2015; U.S. application Ser. No. 14/814,232, filed Jul. 30, 2015; U.S. application Ser. No. 14/814,181, filed Jul. 30, 2015; U.S. application Ser. No. 14/814,274, filed Jul. 30, 2015; U.S. application Ser. No. 14/814,293, filed Jul. 30, 2015; U.S. application Ser. No. 14/814,303, filed Jul. 30, 2015; U.S. application Ser. No. 14/814,363, filed Jul. 30, 2015; U.S. application Ser. No. 14/814,319, filed Jul. 30, 2015; U.S. application Ser. No. 14/814,335, filed Jul. 30, 2015; U.S. Provisional Application No. 62/236,296, filed Oct. 2, 2015; U.S. Provisional Application No. 62/288,549, filed Jan. 29, 2016; U.S. Provisional Application No. 62/288,566, filed Jan. 29, 2016; U.S. Provisional Application No. 62/288,615, filed Jan. 29, 2016; U.S. Provisional Application No. 62/288,695, filed on Jan. 29, 2016; U.S. Provisional Application No. 62/288,755, filed on Jan. 29, 2016.

### BACKGROUND

The disclosure relates generally to photochromic glass, and specifically relates to thermally strengthened photochromic glass and to related methods and systems for the thermal strengthening of photochromic glass, particularly for thin photochromic glass sheets.

In making photochromic glass, an alkali boroaluminosilicate glass composition containing trace amount of halides, silver, and additional sensitizers such as arsenic, antimony, tin, or copper is melted, poured and cooled to form a glass article. The glass article is clear upon cooling and if given the proper reheat and anneal colloidal silver halide crystals with diameters typically ranging between 10 to 500 angstroms precipitate within the glass. The silver halide crystals are transparent to visible light without a significant ultraviolet (UV) radiation component and thus the glass is “clear” when exposed to normal artificial lighting (e.g. indoor lighting). However, when the glass and thus the silver halide crystals are exposed to UV radiation, the silver halide crystals react with the UV radiation and form molecules of elemental silver and the halide. The molecules of elemental silver and halide absorb a significant portion of visible light and the glass darkens in color. When the glass is removed from exposure to the UV radiation, the molecules of elemental silver and the halide recombine to form silver halide crystals and the glass returns to being clear. This reversible silver halide to silver and halide reaction provides a reversible dimming or shading of the glass when exposed to visible light with UV radiation, e.g. sunlight.

Thermal processing parameters for reheat and anneal of a photochromic glass to precipitate the silver halide crystals can be different than thermal processing parameters for thermal strengthening of the photochromic glass. For example, a heat treatment to allow for the precipitation of the silver halide crystals can include holding the glass at its strain point temperature for 16 hours or holding the glass at its softening temperature for 15 minutes. Accordingly, current strengthening of photochromic glasses, particularly thin photochromic glass sheet, is provided via an ion-exchange (chemical) strengthening treatment.

In thermal (or “physical”) strengthening of glass sheets, a glass sheet is heated to an elevated temperature above the glass transition temperature of the glass and then the surfaces of the sheet are rapidly cooled (“quenched”) while the inner regions of the sheet cool at a slower rate. The inner regions cool more slowly because they are insulated by the thickness and the fairly low thermal conductivity of the glass. The differential cooling produces a residual compressive stress in the glass surface regions, balanced by a residual tensile stress in the central regions of the glass.

Thermal strengthening of glass is distinguished from chemical strengthening of glass, in which surface compressive stresses are generated by changing the chemical composition of the glass in regions near the surface by a process such as ion diffusion. In some ion diffusion based processes, exterior portions of glass may be strengthened by exchanging larger ions for smaller ions near the glass surface to impart a compressive stress (also called negative tensile stress) on or near the surface. The compressive stress is believed to limit crack initiation and/or propagation.

Thermal strengthening of glass is also distinguished from glass strengthened by processes in which exterior portions of the glass are strengthened or arranged by combining two types of glass. In such processes, layers of glass compositions that have differing coefficients of thermal expansion are combined or laminated together while hot. For example, by sandwiching molten glass with a higher coefficient of thermal expansion (CTE) between layers of molten glass with a lower CTE, positive tension in the interior glass compresses the outer layers when the glasses cool, again forming compressive stress on the surface to balance the positive tensile stress. This surface compressive stress provides strengthening.

Thermally strengthened photochromic glass has advantages relative to unstrengthened photochromic glass. The surface compression of the strengthened photochromic glass provides greater resistance to fracture than unstrengthened photochromic glass. The increase in strength generally is proportional to the amount of surface compression stress. If a sheet possesses a sufficient level of thermal strengthening, relative to its thickness, then if the sheet is broken, generally it will divide into small fragments rather than into large or elongated fragments with sharp edges. Glass that breaks into sufficiently small fragments, or “dices,” as defined by various established standards, may be known as safety glass, or “fully tempered” glass, or sometimes simply “tempered” glass.

Because the degree of strengthening depends on the temperature difference between the surface and center of the glass sheet during quenching, thinner glasses require higher cooling rates to achieve a given stress. Also, thinner glass generally requires higher values of surface compressive stress and central tension stress to achieve dicing into small particles upon breaking. Accordingly, achieving desirable levels of tempering in glass with thicknesses of around 3 mm or less has been exceedingly challenging, if not impossible.

Aspects of the present disclosure also relate generally to a photochromic glass that has a stress profile for strengthening exterior portions thereof. Photochromic glass, such as sheets of photochromic glass, may be used for a broad range of applications. Examples of such applications include self-tinting sunglasses, industrial applications such as sensors, novelty items such as toys, or other applications.

### SUMMARY

This disclosure relates, in part, to highly strengthened thin photochromic glass sheets and articles, and to methods, processes, and systems that achieve surprisingly high levels of heat strengthening of photochromic glass sheets at thicknesses not achieved in the past. In various embodiments, the process and method of the current disclosure is believed to surpass the photochromic glass thickness limits and heat transfer rates provided by conventional convective gas thermal strengthening processes without the need to contact the photochromic glass with liquid or solid heat sinks. In such systems and processes, during quenching, the photochromic glass is contacted only with a gas. The systems and methods disclosed enable thermal strengthening, including up to “full temper” or dicing behavior, in photochromic glass sheets having thicknesses down to at least as thin as 0.1 mm (in at least some contemplated embodiments); and in some embodiments, provides this strengthening in a thin photochromic glass sheet that also has a low roughness and a high degree of flatness resulting from the lack of liquid or solid contact during quenching. In various embodiments, these advantageous photochromic glass sheet material properties are provided by a system and method with substantially lower quenching power requirements, as compared to conventional convective glass tempering systems.

One embodiment of the disclosure relates to a process for thermally strengthening a photochromic glass material. The process includes providing article formed from a photochromic glass material. The process includes heating the article above a glass transition temperature of the photochromic glass material and precipitating crystals of a silver halide having diameters in the range of tens of angstroms (\acute{Å}) to hundreds of \acute{Å}, e.g. 10-999 \acute{Å}. The process includes moving the heated article into a cooling station. The cooling station includes a heat sink having a heat sink surface facing the heated article and a gas gap separating the heat sink surface from the heated article such that the heat sink surface does not touch the heated article. The process includes cooling the heated article to a temperature below the glass transition temperature such that surface compressive stresses and central tensile stresses are created within the article. The article is cooled by transferring thermal energy from the heated article to the heat sink by conduction across the gap such that more than 20% of the thermal energy leaving the heated article crosses the gap and is received by the heat sink.

Another embodiment of the disclosure relates to a system for thermally strengthening a photochromic glass sheet. The system includes a heating station including a heating element delivering heat to the photochromic glass sheet and precipitating crystals of silver halide. The photochromic glass sheet includes a first major surface, a second major surface and a thickness between the first and second major surfaces. The system includes a cooling station, including opposing first and second heat sink surfaces defining a channel therebetween such that during cooling the photochromic glass sheet is located within the channel. The system includes a gas bearing delivering pressurized gas to the channel such that the photochromic glass sheet is supported within the channel without touching the first and second heat sink surfaces, and the gas bearing defines a gap area. The gas bearing delivers a gas into the channel such that a total mass flow rate of gas into the channel is greater than zero and less than 2k/gCₚ per square meter of gap area, where k is the thermal conductivity of a gas within the channel evaluated in the direction of heat conduction, g is the distance between the photochromic glass sheet and the heat sink surface, and Cₚ is the specific heat capacity of the gas within the channel.

Another embodiment of the disclosure relates to a strengthened photochromic glass article. The article includes a first major surface, a second major surface opposite the first major surface and an interior region located between the first and second major surfaces. The article includes an average thickness between the first major surface and second major surface of less than 2 mm. An ion content and chemical constituency of at least a portion of both the first major surface and the second major surface is the same as an ion content and chemical constituency of at least a portion of the interior region. The first major surface and the second major surfaces are under compressive stress and the interior region is under tensile stress, and the compressive stress is greater than 150 MPa. A surface roughness of the first major surface is between 0.2 and 1.5 nm Rₐ roughness.

Additional features and advantages will be set forth in the detailed description that follows, and, in part, will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding and are incorporated in and constitute a part of this specification. The drawings illustrate one or more embodiments, and together with the description serve to explain principles and the operation of the various embodiments.

### BRIEF DESCRIPTION OF THE DRAWINGS

FIG. 1 (Prior Art) is a graph of blower power required for “full tempering” as a function of glass thickness.

FIG. 2 (Prior Art) is a graph of blower power required for “full tempering” as a function of glass thickness for an old process or machine O and a newer process or machine N.

FIG. 3 (Prior Art) is a graph of the old curve O and the new curve N of FIG. 2 scaled to match and superimposed upon the graph of FIG. 1.

FIG. 4 is a perspective view of a photochromic glass article or sheet according to an exemplary embodiment.

FIG. 5 is a diagrammatic partial cross-section of a thermally strengthened glass sheet of FIG. 4 according an exemplary embodiment.

FIG. 6 is a graphical representation of estimated tensile stress versus thickness for a glass article according to an exemplary embodiment.

FIG. 7 shows a portion of a fractured glass article according to an exemplary embodiment.

FIG. 8 is a plot of fragmentation per square centimeter as a function of positive tensile stress from experiment.

FIG. 9 is a plot of the magnitude of negative tensile stress at the surface as a function of initial hot zone temperature from experiment, showing a threshold to achieve dicing.

FIG. 10 is a plot of the non-dimensional surface fictive temperature parameter θs for fictive temperatures obtained by one or more embodiments of methods and systems of the present invention.

FIG. 11 is a plot of surface compression stresses calculated by simulation for differing glass compositions, plotted against a proposed temperability parameter Ψ for the various compositions shown.

FIGS. 12 and 13 are graphs of two parameters P₁ and P₂ as functions of heat transfer coefficient h.

FIG. 14 is a graph of MPa of surface compression of a glass sheet as a function of thickness t of the sheet in millimeters, showing regions of performance newly opened by one or more embodiments of the systems and methods of the present disclosure.

FIG. 15 is a graph showing compressive stress as a function of thickness plotted for selected exemplary embodiments of tempered glass sheets of the present disclosure.

FIG. 16 is a flow chart illustrating some aspects of a method according to the present disclosure.

FIG. 17 is a flow chart illustrating some aspects of another method according to the present disclosure.

FIG. 18 is the graph of FIG. 3 with a region R and points A, B, A′ and B′ marked thereon to show a region in which the methods and systems of the present disclosure allow operation, in contrast to the prior art.

FIG. 19 is another representation of the region R and points A, B, A′ and B′ of FIG. 18, but shown adjacent to (and positioned relative to the scale) of a reduced size copy of FIG. 2.

FIG. 20 (Prior Art) is a graph of the required heat transfer coefficient needed for tempering as a function of glass thickness.

FIG. 21 is a diagrammatic cross-section of a glass sheet being cooled by conduction more than by convection, according to an exemplary embodiment.

FIG. 22 is a schematic cross-sectional diagram of a conductive strengthening system according to an exemplary embodiment.

FIG. 23 is a perspective cut-away view of another embodiment of a system similar to that of FIG. 22 according to an exemplary embodiment.

FIG. 24 is a perspective cut-away view of an alternative embodiment of the inset feature of FIG. 23 according to an exemplary embodiment.

FIG. 25 is a perspective cut-away view of yet another alternative embodiment of the inset feature of FIG. 23 according to an exemplary embodiment.

FIG. 26 is a flow chart illustrating some aspects of yet another method according to an exemplary embodiment.

FIG. 27 is a perspective view of a building with glass windows according to an exemplary embodiment.

FIG. 28 is a perspective view of a glass article or sheet according to an exemplary embodiment.

### DETAILED DESCRIPTION

Applicant has recognized a need for improvements in thermal processing of photochromic glass, both in methods and systems for thermally strengthening photochromic glass and the resulting thermally strengthened photochromic glass sheets themselves. For example, thinner, but strong optical-quality photochromic glass sheet materials and products comprising such photochromic glass sheets are useful for a number of applications, including ophthalmic lenses, industrial applications such as sensors, novelty items such as toys, etc. It is appreciated that glass is very strong in compression but relatively weak against tension at the surface. By providing compression at the surface of a sheet, balanced by tension at the center where there is no exposed surface, the useful strength of a photochromic glass sheet is dramatically increased. However, while traditional thermal strengthening of glass is generally cheaper and faster relative to alternative methods of strengthening (e.g., chemical strengthening, lamination-based strengthening), traditional thermal strengthening of glass is not known to be effective for strengthening thin photochromic glass (e.g., photochromic glass sheets of 2-3 mm or less). Traditional thermal glass strengthening methods are typically thought to be limited to thicker glass sheets because the level of strengthening depends on the temperature difference created between the surface and the center of the glass sheet during quenching; and because of thermal conduction rate limitations of traditional strengthening methods, it is difficult to achieve significant temperature differences between the surface and the center of a thin photochromic glass sheet due to the relatively even cooling that typically occurs throughout a thin glass sheet.

On the other hand, strengthening thin photochromic glass through ion exchange can be time-consuming and cumbersome, such as requiring chemical bathing of the photochromic glass for extended periods of time. Laminating photochromic glass directly to a different type of glass may require complicated manufacturing processes, such as involving a dual-isopipe fusion draw.

Therefore, a need exists for photochromic glass articles having stress profiles that result in strengthening of the photochromic glass for a variety of uses such as in ophthalmic lenses, sensors, toys, etc. Specifically, processes and systems discussed herein form photochromic glass articles having stress profiles that strengthen the exterior portions of the photochromic glass, which in turn act to mitigate cracking and damage while at the same time allowing for a variety of other desirable photochromic glass qualities (e.g., geometry, surface quality, low birefringence, low refraction index variation, reversible darkening and fading, etc.) to facilitate the use in various photochromic glass applications.

The present description provides improved methods and systems for utilizing thermal strengthening to produce highly strengthened photochromic glass materials, and in particular highly strengthened thin photochromic glass sheets. The methods and systems solve a variety of the limitations of conventional photochromic glass strengthening processes, allowing for high levels of strengthening in photochromic glass sheets with thicknesses less than about 8 mm, 7 mm, 6 mm, 5 mm, 4 mm, 3 mm, less than 2 mm, less than 1.5 mm, less than 1.0 mm, less than 0.5 mm, less than about 0.25 mm, and less than about 0.1 mm. In particular, Applicant has developed a system and method that provides a very high rate of thermal conduction forming a large enough temperature differential between the surface and center of a photochromic glass sheet to provide strengthening or tempering even in very thin photochromic glass sheets.

### Overview of Photochromic Glass

Photochromic glasses are now well known and are characterized by their ability to darken when exposed to actinic radiation, essentially ultraviolet radiation, and to brighten when this excitatory source disappears. Since the invention of photochromic glasses by Pierson and Stookey (U.S. Pat. No. 3,208,860), now over 50 years ago, they have been applied with variations in a great number of versions, depending on whether one or the other of the attributes of photochromism was optimized for particular application. In general, the critical attributes of the photochromic glasses for ophthalmic applications are: their color and level of transmission in the clear state (in the absence of actinic radiation), their color (usually gray or brown) and transmission after darkening resulting from exposure to actinic radiation, the low amplitude of the variation in the level of transmission in the darkened state as a function of the temperature, normally between 0 and 40° C., and their ability to brighten reversibly when the excitatory light source disappears.

As disclosed in the Pierson-Stookey patent, polychromatic glasses can be composed of a wide range of base compositions. However, each must contain silver, an alkali metal oxide (preferably Na₂O), fluoride, and at least one halide selected from the group of chloride, bromide, and iodide. The glasses may be irradiated with either high energy or actinic radiations. Where the actinic radiation is supplied as ultraviolet radiation, cerium oxide (CeO₂) is a required component of the glass composition.

Continuing efforts have been made to improve early photochromic glasses with respect to both their photochromic properties and their other properties necessary for ophthalmic use, such as glass compositions disclosed in U.S. Pat. Nos. 4,204,027; 4,190,541; 4,168,339; 4,148,661; and 4,018,965, incorporated herein by reference. For example, U.S. Pat. No. 4,190,451 (Hares et al.) disclosed an R₂O—Al₂O₃—B₂O₃—SiO₂ base glass containing, as essential constituents for photochromism, 0.15-0.3% Ag; 0.1-0.25% Cl; 0.1-0.2% Br and 0.004-0.02% CuO by weight. The patent also disclosed the possibility of adding up to one percent transition metal oxides, such as CoO, NiO and Cr₂O₃, and up to five percent rare earth metal oxides, such as Er₂O₃, as glass colorants. A composition for a commercial, photochromic sunglass was developed on the basis of the Hares et al. patent teachings. This glass has a base glass composition, as calculated in parts by weight from the glass batch, of 56.46 SiO₂; 4.08 Na₂O; 6.19 A₂O₃; 5.72 K₂O; 18.15 B₂O₃; 4.99 ZrO₂; 1.81 Li₂O; 2.09 TiO₂. The glass contains photochromic elements as follows (wt %): 0.252 Ag; 0.195 Cl; 0.155 Br; and 0.006 CuO. The glass also has 0.122 NiO and 0.017 Co₃O₄ added to impart a fixed tint.

More recent photochromic glass development has led to U.S. Pat. No. 9,145,330 (Brocheton) with a rare earth-free composition range (wt %) of 48≤SiO2≤58; 15≤B2O3≤21; 5≤Al2O3≤9; 2.5≤ZrO2≤6.5; 2≤Li2O≤4; 0≤Na2O≤3; 3≤K2O≤10; 0≤MgO≤2; 0≤CaO≤2; 0≤SrO≤2; 0≤BaO≤2; 0≤TiO2≤2.5; 2≤Nb2O5≤4.5; and a plurality of photochromic agents, comprising in weight percent (wt %) with respect to the glass matrix: 0.100≤Ag≤0.250; 0.200≤Cl≤0.500; 0.0100≤Br≤0.300; and 0.0050≤CuO≤0.0110. As such, it is appreciated that a wide range of photochromic glass compositions are covered by the instant disclosure and can be photochromically processed and thermally strengthened using one or more embodiments disclosed herein.

### Overview of Conventional Thermal Tempering Technology and Limitations

Conventional industrial processes for thermally strengthening glass involve heating glass sheets in a radiant energy furnace or a convection furnace (or a “combined mode” furnace using both techniques) to a predetermined temperature, then gas cooling (“quenching”), typically via convection by blowing large amounts of ambient air against or along the glass surface. This gas cooling process is predominantly convective, whereby the heat transfer is by mass motion (collective movement) of the fluid, via diffusion and advection, as the gas carries heat away from the hot glass sheet.

In conventional tempering processes, certain factors can restrict the amount of strengthening typically considered possible in glass sheets, particularly thin glass sheets. Limitations exist, in part, because the amount of compressive stress on the finished sheet is related directly to the size of the temperature differential between the surface and the center of the sheet, achieved during quenching. However, the larger the temperature differential during quenching, the more likely glass is to break during quenching. Breakage can be reduced, for a given rate of cooling, by starting the quench from a higher initial glass temperature. Also, higher starting temperatures typically allow the tempered glass sheet to achieve the full strengthening potential provided by high cooling rates. However, increasing the temperature of the sheet at the start of the quench also has its own potential drawbacks. For example, high initial glass temperatures can lead to excessive deformation of the sheet as it becomes softer, again limiting the practically achievable temperature differential.

In conventional tempering processes, sheet thickness also imposes significant limits on the achievable temperature differential during quenching. The thinner the sheet, the lower the temperature differential between the surface and the center for a given cooling rate during quenching. This is because there is less glass thickness to thermally insulate the center from the surface. Accordingly, thermal strengthening of thin glass typically requires higher cooling rates (as compared to thermal strengthening of thicker glass) and, thus, faster removal of heat from the external surfaces of the glass typically requires significant energy consumption in order to generate strengthening levels of differential temperature between the inner and outer portions of the glass sheet.

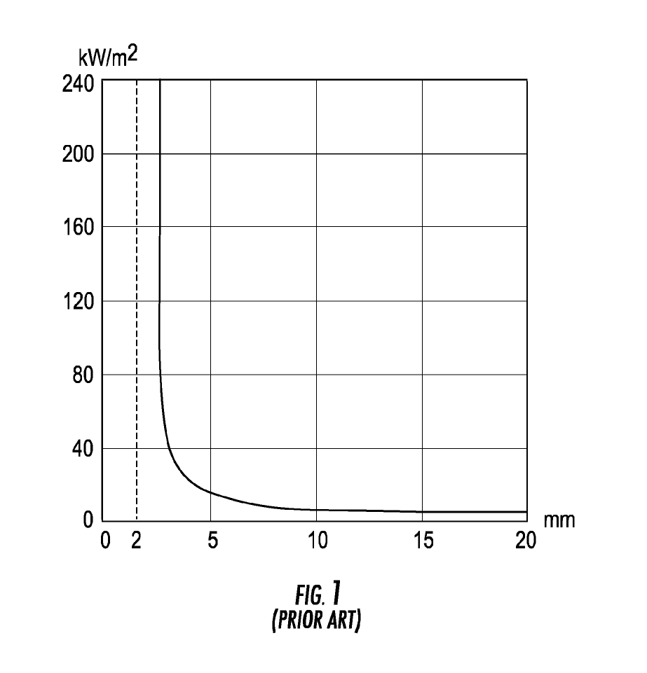

By way of example, FIG. 1 shows the power required by air blowers (in kilowatts per square meter of glass sheet area) employed to blow sufficient ambient air to “fully temper” soda-lime glass (“SLG”), as a function of glass thickness in millimeters, based on industry standard thermal strengthening processes developed 35 years ago. The power required increases exponentially as the glass used gets thinner. Thus, glass sheets of about 3 mm in thickness were the thinnest fully thermally tempered commercial glass available for many years.

Further, the thinner the sheet, the greater the likelihood of deformation at a given softness (that is, at a given viscosity) of the glass. Therefore, decreasing thickness both reduces the achievable temperature differential directly and, because of increased risk of deformation of the sheet, tends to reduce the opportunity to use higher sheet temperatures to achieve the full benefits of higher cooling rates and to prevent glass breakage caused by higher cooling rates. Thus, in conventional convective gas glass strengthening processes, higher rates of cooling are achieved by increasing the rate of air flow, decreasing the distance of air nozzle openings to the glass sheet surface, increasing the temperature of the glass (at the start of cooling), and optionally, decreasing the temperature of the cooling air.

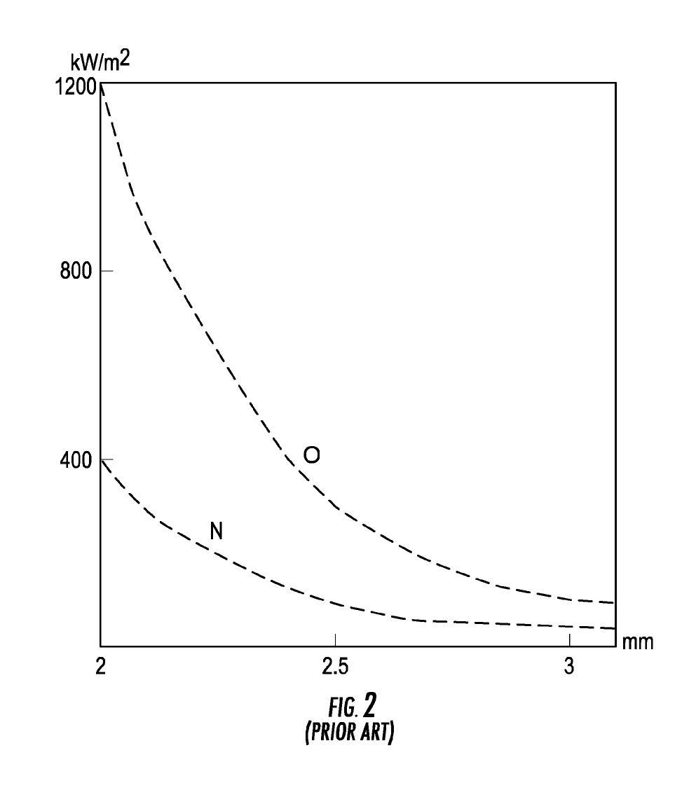

As a more recent example, the performance curves of FIG. 2 (Prior Art) were published using state of the art glass thermal strengthening equipment. This improved equipment continues to use traditional air blown convective processes to cool the glass, but replaces rollers used to support the glass during heating with a system that utilizes air to support the glass during at least the last stages of heating. Without roller contact, the glass can be heated to higher temperatures (and higher softness/lower viscosity) prior to quenching, reportedly allowing the production of fully tempered glass at 2 mm thickness. As shown in FIG. 2, the reported blower power required to strengthen a 2 mm thick sheet is reduced from 1200 kW/m² to 400 kW/m² at the higher temperatures enabled by using air to support the glass (curve N) as compared to using rollers (curve O).

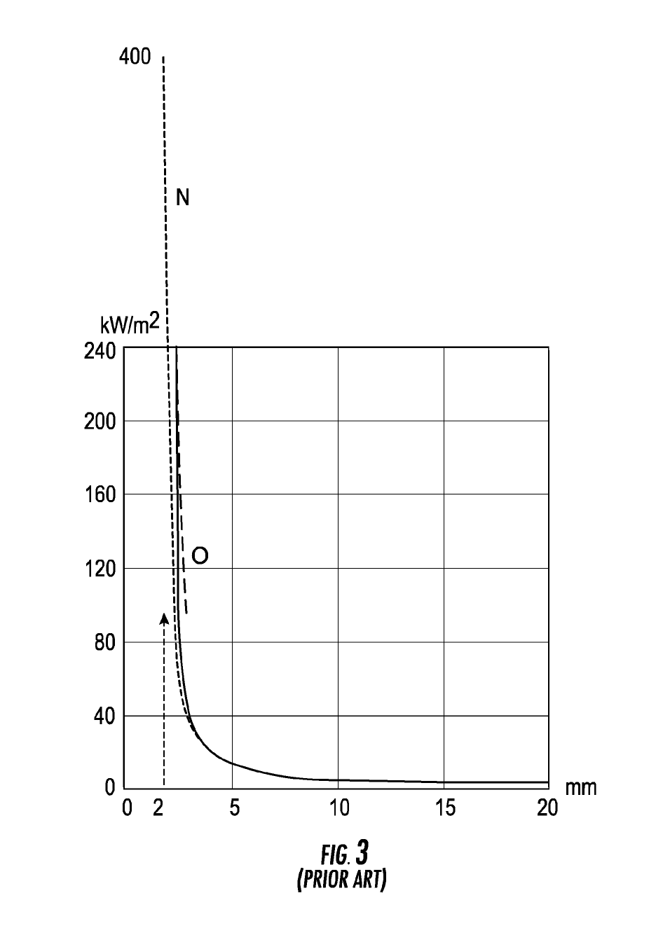

Although it represents progress to be able to produce fully tempered 2 mm thick glass, scaling the old and new curves O and N of FIG. 2 to match the scale of FIG. 1, as shown in FIG. 3 (Prior Art), shows that the improvement in performance achieved by the state of the art convective tempering process (shown in FIG. 2) is relatively small and simply an incremental change in the previous understanding of the energy needs in convective strengthening of glass sheets. In FIG. 3 the old and new curves O and N of FIG. 2 are scaled to match the graph of FIG. 1, and overlaid thereon (with the old curve O truncated at the top at 240 kW/m² for easier viewing of the new curve N). From FIG. 3 it is apparent that the technology represented by the curve N changes only slightly the performance curve of convective gas quenching processes as glass thickness is decreased from 3 mm to 2 mm. The high operating point (400 kW/m² of blower power for 2 mm glass) shows the extreme increase in power still required to process thinner glass by this method. The sharp increase in airflow and, thus, power needed suggests the difficulty, as a matter of both engineering practice and economics, in going below 2 mm thickness while producing fully tempered glass using conventional convective gas strengthening methods. Additionally, the very high airflows needed also could deform the shape of thinner sheets. Accordingly, to reach full temper of glass having a thickness of less than 2 mm or to reach full temper at 2 mm in glasses having coefficients of thermal expansion (“CTE”) lower than that of soda-lime glasses using thermal tempering, Applicant has identified that another tempering method/system is needed.

Alternative thermal strengthening methods to current commercial convective gas strengthening have been tried as well, but each has certain drawbacks relative to convective gas strengthening. In particular, typical alternative thermal strengthening methods that achieve higher cooling rates generally require at least some liquid or solid contact with the glass surfaces, rather than gas contact only. Such contact with the glass sheet can adversely affect glass surface quality, glass flatness, and/or evenness of the strengthening process. These defects sometimes can be perceived by the human eye, particularly when viewed in reflected light, and can denigrate desired properties of photochromic glass used in ophthalmic lenses, sensors, etc. As described in more detail below, at least in some embodiments, the conductive thermal tempering system of the present disclosure reduces or eliminates such contact-related defects.

Liquid contact strengthening, in the form of immersion in liquid baths or flowing liquids, as well as in the form of spraying, has been used to achieve higher cooling rates than convective gas strengthening, but has the drawback of causing excessive thermal variations across a sheet during the cooling process. In immersion or immersion-like spraying or flowing of liquids, large thermal variations over small areas can occur due to convection currents that arise spontaneously within the liquid bath or liquid flow. In finer spraying, the discrete spray droplets and the effects of nozzle spray patterns also produce significant thermal variations. Excessive thermal variations tend to cause glass breakage during thermal strengthening by liquid contact, which can be mitigated by limiting the cooling rates, but limiting cooling rates also lowers the resulting strengths that can be achieved. Further, the necessary handling of the sheet (to position or hold it within the liquid bath or liquid flow or liquid spray) also causes physical stress and excessive thermal variations from physical contact with the sheet, tending also to cause breakage during strengthening and limiting the cooling rates and resulting strengths. Finally, some liquid cooling methods, such as high cooling rate quenching by oil immersion and various spraying techniques, can alter the glass surface during such cooling, requiring later removal of glass material from the sheet surface to produce a satisfactory finish.

Solid contact thermal strengthening involves contacting the surface of the hot glass with a cooler solid surface. As with liquid contact strengthening, excessive thermal variations, like those seen in liquid contact strengthening, can easily arise during the quenching process. Any imperfection in the surface finish of the glass sheet, in the quenching surfaces, or in the consistency of the thickness of the sheet, results in imperfect contact over some area of the sheet, and this imperfect contact may cause large thermal variations that tend to break the glass during processing and may also cause unwanted birefringence if the sheet survives. Additionally, contacting the hot glass sheet with a solid object can lead to the formation of surface defects, such as chips, checks, cracks, scratches, and the like. Achieving good physical contact over the entirety of the surfaces of a glass sheet also can become increasing difficult as the dimensions of the sheet increase. Physical contact with a solid surface also can mechanically stress the sheet during quenching, adding to the likelihood of breaking the sheet during the process. Further, the extreme high rate temperature changes at the initiation of contact can cause breakage during sheet processing and, as such, contact cooling of thin glass substrates and particularly thin photochromic glass substrates has not been commercially viable.

### Overview of Applicant's Thermally Strengthened Photochromic Glass and Related Conductive Cooling Process and Method

The present disclosure surpasses the traditional processes described above to effectively, efficiently, and evenly thermally strengthen thin photochromic glass sheets at commercial scales without generating various flaws common in conventional processes, e.g., without damaging the surface of the photochromic glass, without inducing birefringence, without uneven strengthening, and/or without causing unacceptable breakage, etc. Previously unobtainable, thin, thermally tempered/strengthened photochromic glass sheets can be produced by one or more of the embodiments disclosed herein. The systems and processes discussed herein accomplish this by providing very high heat transfer rates in a precise manner, with good physical control and gentle handling of the photochromic glass. In particular embodiments, the processes and systems discussed herein utilize a small-gap, gas bearing in the cooling/quenching section that Applicant has identified as allowing for processing thin photochromic glass sheets at higher relative temperatures at the start of cooling, resulting in higher thermal strengthening levels. As described below, this small-gap, gas bearing cooling/quenching section achieves very high heat transfer rates via conductive heat transfer to heat sink(s) across the gap, rather than using high air flow based convective cooling. This high rate conductive heat transfer is achieved while not contacting the photochromic glass with liquid or solid material, by supporting the photochromic glass on gas bearings within the gap. As described below, Applicant has also identified that, in at least some embodiments, the processes and systems discussed herein form thermally strengthened photochromic glass, specifically thermally strengthened thin photochromic glass, having one or more unique properties.

Some embodiments of photochromic glass sheets treated by methods and/or systems according to the present disclosure have higher levels of permanent thermally induced stresses than previously known. Without wishing to be bound by theory, it is believed that the achieved levels of thermally induced stress are obtainable for a combination of reasons. The high uniformity of the heat transfer in the processes detailed herein reduces or removes physical and unwanted thermal stresses in the photochromic glass, allowing photochromic glass sheets to be tempered at higher heat transfer rates without breaking. Further, the present methods can be performed at lower photochromic glass sheet viscosities (higher initial temperatures at the start of quench), while still preserving the desired photochromic glass flatness and form, which provides a much greater change in temperature in the cooling process, thus increasing the heat strengthening levels achieved.

### Thermally Tempered Photochromic Glass Sheet

As noted above, Applicant has developed a system and process for forming thermally strengthened photochromic glass sheets, particularly thin photochromic glass sheets, and as discussed in this section, the thermally strengthened, thin photochromic glass sheets formed as discussed herein have one or more unique properties and/or combinations of properties, previously unachievable through conventional thermal or other tempering methods.

### Thermally Tempered Photochromic Glass Sheet Structure and Dimensions

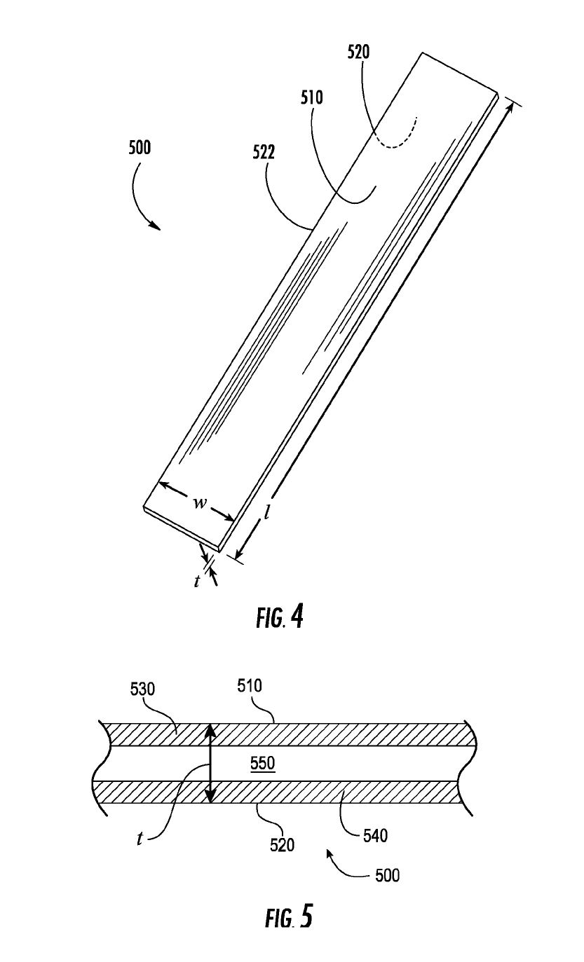

Referring to FIG. 4 and FIG. 5, a thermally strengthened photochromic glass sheet having a high surface compressive stress and/or a high central tension is shown according to an exemplary embodiment. FIG. 4 shows a perspective view of a thermally strengthened photochromic glass article or sheet 500, and FIG. 5 is a diagrammatic partial cross-section of thermally strengthened photochromic glass sheet 500 according to one or more embodiments.

As shown in FIG. 4, a strengthened photochromic glass article 500 (e.g., sheet, beam, plate), includes a first major surface 510, a second major surface 520 (dotted line to back side of the sheet 500, which may be translucent as disclosed herein), and a body 522 extending therebetween. The second major surface 520 is on an opposite side of the body 522 from the first major surface 510 such that a thickness t of the strengthened photochromic glass sheet 500 is defined as a distance between the first and second major surfaces 510, 520, where the thickness t is also a dimension of depth. A width, w, of the strengthened photochromic glass sheet 500 is defined as a first dimension of one of the first or second major surfaces 510, 520 orthogonal to the thickness t. A length, l, of the strengthened photochromic glass sheet 500 is defined as a second dimension of one of the first or second major surfaces 510, 520 orthogonal to both the thickness t and the width w.

In exemplary embodiments, thickness t of photochromic glass sheet 500 is less than length l of photochromic glass sheet 500. In other exemplary embodiments, thickness t of photochromic glass sheet 500 is less than width w of photochromic glass sheet 500. In yet other exemplary embodiments, thickness t of photochromic glass sheet 500 is less than both length l and width w of photochromic glass sheet 500. The length l and/or width w can be greater than 0.5 meters, greater than 1.0 meters or greater than 2.0 meters. Accordingly, large pieces of photochromic glass sheet 500 can be thermally processes using the systems and processes disclosed herein. As shown in FIG. 5, photochromic glass sheet 500 further has regions of permanent thermally induced compressive stress 530 and 540 at and/or near the first and second major surfaces 510, 520, balanced by a region of permanent thermally induced central tensile stress 550 (i.e., tension) in the central portion of the sheet.

The methods and systems may be used to form strengthened photochromic glass sheets having a wide variety of thickness ranges. In various embodiments, thickness t of photochromic glass sheet 500 ranges from 0.1 mm to 8.0 mm or 0.10 to 5.7 or 6.0 mm, including, in addition to the end point values, 0.2 mm, 0.28 mm, 0.4 mm, 0.5 mm, 0.55 mm, 0.7 mm, 1 mm, 1.1 mm, 1.5 mm, 1.8 mm, 2 mm, and 3.2 mm. Contemplated embodiments include thermally strengthened photochromic glass sheets 500 having thicknesses tin ranges from 0.1 to 20 mm, from 0.1 to 16 mm, from 0.1 to 12 mm, from 0.1 to 8 mm, from 0.1 to 6 mm, from 0.1 to 4 mm, from 0.1 to 3 mm, from 0.1 to 2 mm, from 0.1 to less than 2 mm, from 0.1 to 1.5 mm, from 0.1 to 1 mm, from 0.1 to 0.7 mm, from 0.1 to 0.5 mm and from 0.1 to 0.3 mm.

In some embodiments, photochromic glass sheets of 3 mm or less in thickness are used. In some embodiments, the photochromic glass thickness is about (e.g., plus or minus 1%) 8 mm or less, about 6 mm or less, about 3 mm or less, about 2.5 mm or less, about 2 mm or less, about 1.8 mm or less, about 1.6 mm or less, about 1.4 mm or less, about 1.2 mm or less, about 1 mm or less, about 0.8 mm or less, about 0.7 mm or less, about 0.6 mm or less, about 0.5 mm or less, about 0.4 mm or less, about 0.3 mm or less, or about 0.28 mm or less.

In some embodiments, thermally strengthened photochromic glass sheets have high aspect ratios—i.e., the length and width to thickness ratios are large. Because the thermal tempering processes discussed herein do not rely on high pressures or large volumes of air, various photochromic glass sheet properties, such as surface roughness and flatness, can be maintained after tempering by the use of gas bearings and high thermal transfer rate systems discussed herein. Similarly, the thermal tempering processes discussed herein allow high aspect ratio photochromic glass sheets (i.e., photochromic glass sheets with high ratio of length to thickness, or of width to thickness, or both) to be thermally strengthened while retaining the desired or necessary shape. Specifically, sheets with length to thickness and/or width to thickness ratios (“aspect ratios”) of approximately at least 10:1, at least 20:1, and up to and over 1000:1 can be strengthened. In contemplated embodiments, sheets with aspect ratios of at least 200:1, at least 500:1, at least 1000:1, at least 2000:1, at least 4000:1 can be strengthened.

According to an exemplary embodiment, the length l of the strengthened photochromic glass sheet 500 is greater than or equal to the width w, such as greater than twice the width w, greater than five times the width w, and/or no more than fifty times the width w. In some such embodiments, the width w of the strengthened photochromic glass sheet 500 is greater than or equal to the thickness t, such as greater than twice the thickness t, greater than five times the thickness t, and/or no more than fifty times the thickness t.

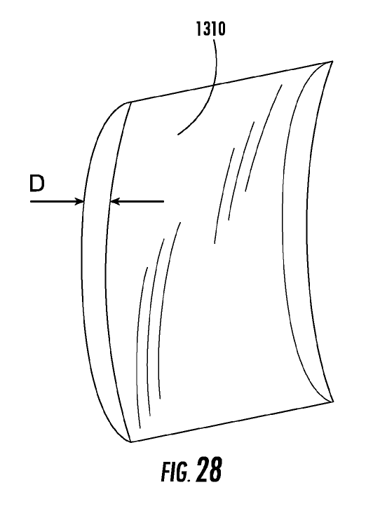

In some embodiments, such as for applications disclosed with regard to FIGS. 27-28 discussed below, for example, the length l of the photochromic glass sheet 500 is at least 1 cm, such as at least 3 cm, at least 5 cm, at least 7.5 cm, at least 20 cm, at least 50 cm, and/or no more than 50 m, such as no more than 10 m, no more than 7.5 m, no more than 5 m. In some such embodiments, the width w of the photochromic glass sheet 500 is at least 1 cm, such as at least 3 cm, at least 5 cm, at least 7.5 cm, at least 20 cm, at least 50 cm, and/or no more than 50 m, such as no more than 10 m, no more than 7.5 m, no more than 5 m. Referring to FIG. 4, photochromic glass is in the form a sheet 500 has a thickness t that is thinner than 5 cm, such as 2.5 cm or less, 1 cm or less, 5 mm or less, 2.5 mm or less, 2 mm or less, 1.7 mm or less, 1.5 mm or less, 1.2 mm or less, or even 1 mm or less in contemplated embodiments, such as 0.8 mm or less; and/or the thickness t is at least 10 μm, such as at least 50 μm, at least 100 μm, at least 300 μm.

In other contemplated embodiments, the photochromic glass article may be sized other than as disclosed herein. In contemplated embodiments, the length l, width w, and/or thickness t of the photochromic glass articles may vary, such as for more complex geometries (see generally FIG. 28), where dimensions disclosed herein at least apply to aspects of the corresponding photochromic glass articles having the above-described definitions of length l, width w, and thickness t with respect to one another.

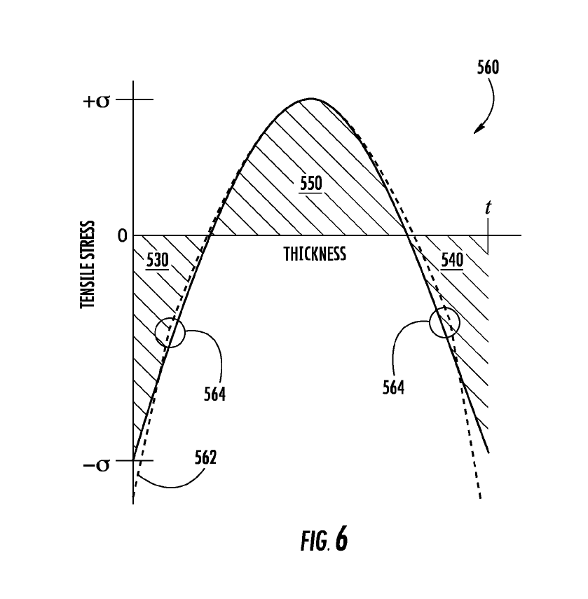

In some embodiments, at least one of the first or second surfaces 510, 520 of photochromic glass sheet 500 has a relatively large surface area. In various embodiments, first and/or second surfaces 510, 520 having areas of at least 100 mm², such as at least 900 mm², at least 2500 mm², at least 5000 mm², at least 100 cm², at least 900 cm², at least 2500 cm², at least 5000 cm², and/or no more than 2500 m², such as no more than 100 m², no more than 5000 cm², no more than 2500 cm², no more than 1000 cm², no more than 500 cm², no more than 100 cm². As such, the photochromic glass sheet 500 may have a relatively large surface area; which, except by methods and systems disclosed herein, may be difficult or impossible to thermally strengthen particularly while having the thicknesses, surface qualities, and/or strain homogeneities of the photochromic glass sheets discussed herein. Further, except by methods and systems disclosed herein, it may be difficult or impossible to achieve the stress profile, particularly the negative tensile stress portion of the stress profile (see generally FIG. 6), without relying upon ion-exchange or a change in the type of photochromic glass.

### Thermally Strengthened Photochromic Glass Sheet Compressive and Tensile Stresses

As noted above, the thermally strengthened photochromic glass sheets discussed herein may have surprisingly high surface compressive stresses, e.g., in regions 530, 540 shown in FIG. 5, surprisingly high central tensile stresses, e.g., in region 550 shown in FIG. 5, and/or unique stress profiles (see FIG. 6). This is particularly true considering the low thickness and/or other unique physical properties (e.g., very low roughness, high degree of flatness, various optical properties, fictive temperature properties, etc.) of photochromic glass sheet 500 as discussed herein.

Compressive stresses of photochromic glasses (e.g., in regions 530, 540 shown in FIG. 5) formed by the processes and systems disclosed herein can vary as a function of thickness t of the photochromic glasses. In various embodiments, photochromic glasses, e.g., photochromic glass sheet 500, having a thickness of 3 mm or less have a compressive stress (e.g., surface compressive stress) of at least 80 MPa, at least 100 MPa, at least 150 MPa, at least 200 MPa, at least 250 MPa, at least 300 MPa, at least 350 MPa, at least 400 MPa, and/or no more than 1 GPa. In contemplated embodiments, photochromic glasses having a thickness of 2 mm or less have a compressive stress of at least 80 MPa, at least 100 MPa, at least 150 MPa, at least 175 MPa, at least 200 MPa, at least 250 MPa, at least 300 MPa, at least 350 MPa, at least 400 MPa, and/or no more than 1 GPa. In contemplated embodiments, photochromic glasses having a thickness of 1.5 mm or less have a compressive stress of at least 80 MPa, at least 100-MPa, at least 150 MPa, at least 175 MPa, at least 200 MPa, at least 250 MPa, at least 300-MPa, at least 350 MPa, and/or no more than 1 GPa. In contemplated embodiments, photochromic glasses having a thickness of 1 mm or less have a compressive stress of at least 80 MPa, at least 100 MPa, at least 150 MPa, at least 175 MPa, at least 200 MPa, at least 250 MPa, at least 300 MPa, and/or no more than 1 GPa. In contemplated embodiments, photochromic glasses having a thickness of 0.5 mm or less have a compressive stress of at least 50 MPa, at least 80 MPa, at least 100 MPa, at least 150 MPa, at least 175 MPa, at least 200 MPa, at least 250 MPa, and/or no more than 1 GPa.

In some embodiments, the thermally induced central tension in photochromic glasses formed by the processes and systems disclosed herein (e.g., in the region 550 shown in FIG. 5) may be greater than 40 MPa, greater than 50 MPa, greater than 75 MPa, greater than 100 MPa. In other embodiments, the thermally induced central tension may be less than 300 MPa, or less than 400 MPa. In some embodiments, the thermally induced central tension may be from about 50 MPa to about 300 MPa, about 60 MPa to about 200 MPa, about 70 MPa to about 150 MPa, or about 80 MPa to about 140 MPa. In some embodiments, the thermally strengthened photochromic glass sheets have high thinness i.e., are particularly thin. Because very high-heat transfer rates can be applied via the systems and methods discussed herein, significant thermal effects, for example central tensions of at least 10 or even at least 20 MPa, can be produced in sheets of SLG of less than 0.3 mm thickness. In fact, very thin sheets, sheets at least as thin as 0.1 mm, can be thermal strengthened. Specific levels of thermal stresses achieved and achievable, considered as a function of thickness and other variables, are described in further detail herein.

Referring to FIG. 6, a conceptual stress profile 560, at room temperature of 25° C. and standard atmospheric pressure, of the strengthened photochromic glass sheet 500 of FIG. 4, shows an interior portion 550 of the strengthened photochromic glass sheet 500 under positive tensile stress and portions 530, 540 of the strengthened photochromic glass sheet 500 exterior to and adjoining the interior portion 550 under negative tensile stress (e.g., positive compressive stress). Applicant believes that the negative tensile stress at least in part fortifies the strengthened photochromic glass sheet 500 by limiting initiation and/or propagation of cracks therethrough.

Believed unique to the present inventive technology, given relatively large surface areas and/or thin thicknesses of the strengthened photochromic glass sheet 500 as disclosed herein, tensile stress in the stress profile 560 sharply transitions between the positive tensile stress of the interior portion 550 and the negative tensile stress of the portions 530, 540 exterior to and adjoining the interior portion 550. This sharp transition may be understood as a rate of change (i.e., slope) of the tensile stress which may be expressed as a magnitude of stress (e.g., 100 MPa, 200 MPa, 250 MPa, 300 MPa, 400 MPa, a difference in peak values of the positive and negative tensile stresses +σ, −σ) divided by a distance of thickness over which the change occurs, such as a distance of 1 mm, such as a distance of 500 μm, 250 μm, 100 μm (which is the distance used to quantify a rate of change, which may be a portion of article thickness, and not necessarily a dimension of the article geometry). In some such embodiments, the rate of change of the tensile stress does not exceed 7000 MPa divided by 1 mm, such as no more than 5000 MPa divided by 1 mm. In contemplated embodiments, the difference in peak values of the positive and negative tensile stresses is at least 50 MPa, such as at least 100 MPa, at least 150 MPa, at least 200 MPa, at least 250 MPa, at least 300 MPa, at least 400 MPa, at least 500 MPa, and/or no more than 50 GPa. In contemplated embodiments, the photochromic glass sheet 500 has a peak negative tensile stress of at least 50 MPa in magnitude, such as at least 100 MPa, at least 150 MPa, at least 200 MPa, at least 250 MPa, at least 300 MPa, at least 400 MPa, at least 500 MPa. The steep tensile curve transitions generated by the system and method discussed herein are believed to be indicative of the ability to achieve higher magnitudes of negative tensile stress at a surface of a photochromic glass sheet for a given thickness and/or to manufacture thinner photochromic glass articles to a higher degree of negative tensile stress, such as to achieve a fragmentation potential for dicing as disclosed herein. Conventional thermal tempering approaches may be unable to achieve such steep tensile stress curves.

According to an exemplary embodiment, the high rate of change of tensile stress is at least one of the above-described magnitudes or greater sustained over a thickness-wise stretch of the stress profile 560 that is at least 2% of the thickness, such as at least 5% of the thickness, at least 10% of the thickness, at least 15% of the thickness, or at least 25% of the thickness of photochromic glass sheet 500. In contemplated embodiments, the strengthening extends deep into the strengthened photochromic glass sheet 500 such that the thickness-wise stretch with the high rate of change of tensile stress is centered at a depth of between 20% and 80% into the thickness from the first surface, which may further distinguish chemical tempering for example.

In at least some contemplated embodiments, the strengthened photochromic glass article includes a change in the composition thereof in terms of ion content, conceptually shown as dotted line 562 in FIG. 6. More specifically, the composition of the strengthened photochromic glass article 500 in such embodiments includes exchanged or implanted ions that influence the stress profile 560. In some such embodiments, the exchanged or implanted ions do not extend fully through the portions 530, 540 of the strengthened photochromic glass article 500 under the negative tensile stress because the negative tensile stress is also a result of the thermal tempering as disclosed herein.

Accordingly, the curve of the tensile stress profile 560 with ion exchange strength augmentation includes a discontinuity or sudden change 564 in direction where tangents of the curve differ from one another on either side of the discontinuity or sudden change 564. The sudden change 564 is located within the portions 530, 540 under negative tensile stress such that the tensile stress is negative on either side immediately adjacent to the discontinuity or sudden change 564. The discontinuity or sudden change 564 may correspond to the depth of the different ion content, however in some such embodiments other parts of the portions 530, 540 under negative tensile stress still have the same composition in terms of ion content as the portion 550 under positive tensile stress.

Put another way, for at least some strengthened photochromic glass articles 500, with or without ion-exchange or implantation, the composition of at least a part of the portions 530, 540 of the strengthened photochromic glass sheet 500, which is under the negative tensile stress and is exterior to and adjoining the interior portion 550, is the same as the composition of at least a part of the interior portion 550, which is under the positive tensile stress. In such embodiments, at least some of the negative tensile stress of the stress profile is independent of a change in the composition (e.g., ion composition) of the strengthened photochromic glass sheet 500. Such structure may simplify the composition of the strengthened photochromic glass sheet 500 at least to a degree by providing sufficient strength without and/or with less chemical tempering. Further, such structure may reduce stress concentrations within the strengthened photochromic glass sheet 500 due to discontinuity/changes in composition, possibly reducing chances of delamination and/or cracking at the composition discontinuity.

### Thermally Tempered Photochromic Glass Sheet Break Performance

If sufficient energy is stored in the region of tensile stress 550, the photochromic glass will break like safety glass or “dice” when sufficiently damaged. As used herein, a photochromic glass sheet is considered to dice when an area of the photochromic glass sheet 25 cm² breaks into 40 or more pieces. In some embodiments, dicing is used as a qualitative measure of showing that the photochromic glass sheet is “fully tempered” (i.e., for 2 mm or thicker photochromic glass, where the photochromic glass sheet has a compressive stress of at least 65 MPa or an edge compression of at least 67 MPa). In various embodiments, photochromic glass sheet 500 has sufficient tensile stress in region of tensile stress 550 such that a 25 cm² piece of photochromic glass sheet 500 breaks into 40 or more pieces.

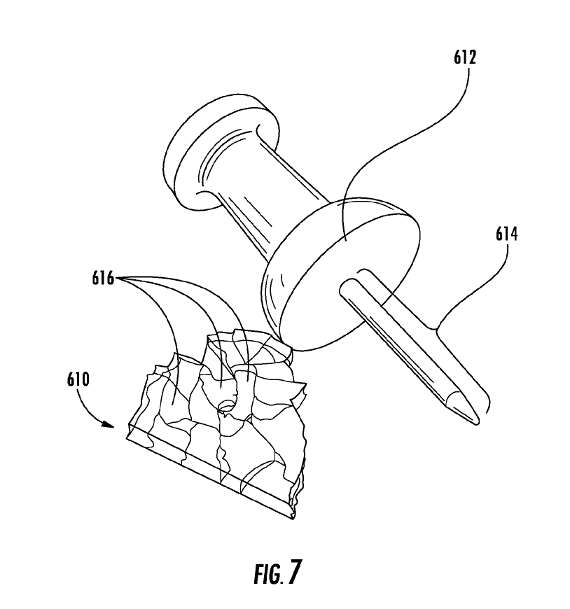

Referring to FIG. 7, a photochromic glass article 610, having properties as disclosed herein with respect to the photochromic glass sheets, such as sheet 500, has been fractured, such as using a prick punch or other instrument and/or generally in accordance with American National Standards Institute (ANSI) Z97.1 (impact test) and the ASTM 1048 standard. According to an exemplary embodiment, the photochromic glass article 610 has been strengthened to a degree that dicing has occurred upon the fracture, forming a plurality of small granular chunks 616 (e.g., fragments, pieces). In some embodiments, the photochromic glass article 610 has a thermally-induced stress sufficient to produce a number of granular chunks 616 that is not less than 40 within an area of 50-by-50 mm of the photochromic glass article 610 in a fragmentation test in which an impact is applied with a hammer or a punch to initiate cracking of the photochromic glass into granular pieces. A standard office thumb tack 612, with a metal pin length 614 of about 1 cm is shown for reference.

According to various contemplated embodiments, despite the thin thickness of the strengthened photochromic glass article 610, the stress profile (see generally FIG. 6) imparts a high fragmentation potential of the strengthened photochromic glass article 610 such that when fractured the strengthened photochromic glass article 610 shatters into particularly small granular chunks 616, those having an area on either the first or second surface of less than 90 mm², such as less than 50 mm², such as less than 20 mm², such as less than 10 mm², such as less than 5 mm², and/or at least 10 μm². In some such embodiments, the fragmentation potential of the strengthened photochromic glass article 610 is such that at least 20% (e.g., at least 50%, at least 70%, at least 95%) of the granular chunks 616 have an area of at least one of the first or second surfaces of one of the above-described amounts when the strengthened photochromic glass article is fractured.

Due at least in part to the particularly thin geometry of the photochromic glass article 610 that may be manufactured with the tensile stresses as disclosed herein using the inventive technology in some embodiments, the fragmentation potential of the strengthened photochromic glass article 610 is such that, when fractured, the strengthened photochromic glass article 610 shatters into particularly low-volume granular chunks, those having a volume of less than 50 mm³, such as less than 40 mm³, such as less than 30 mm³, such as less than 25 mm³, and/or at least a volume of 50 μm³.

Due at least in part to the particularly large area of the photochromic glass article 610 that may be manufactured with the tensile stresses as disclosed herein using the inventive technology in some embodiments, the fragmentation potential of the strengthened photochromic glass article 610 is such that, when fractured, the strengthened photochromic glass article 610 shatters into at least 100 granular chunks 616 of at least of 50 μm³ in volume, such as at least 200, at least 400, at least 1000, at least 4000 granular chunks 616 of at least of 50 μm³ in volume.

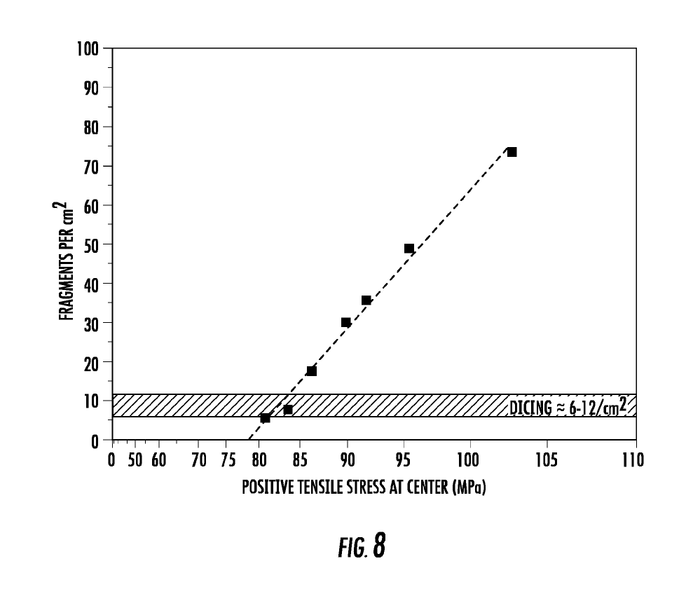

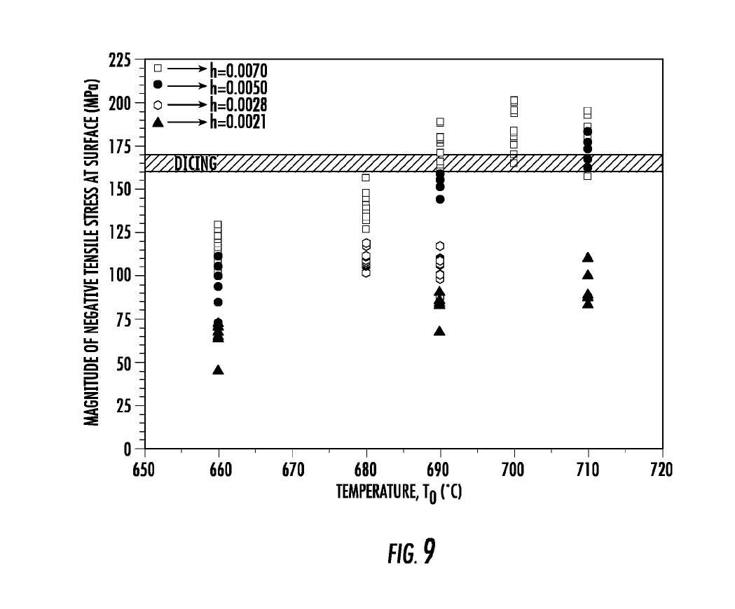

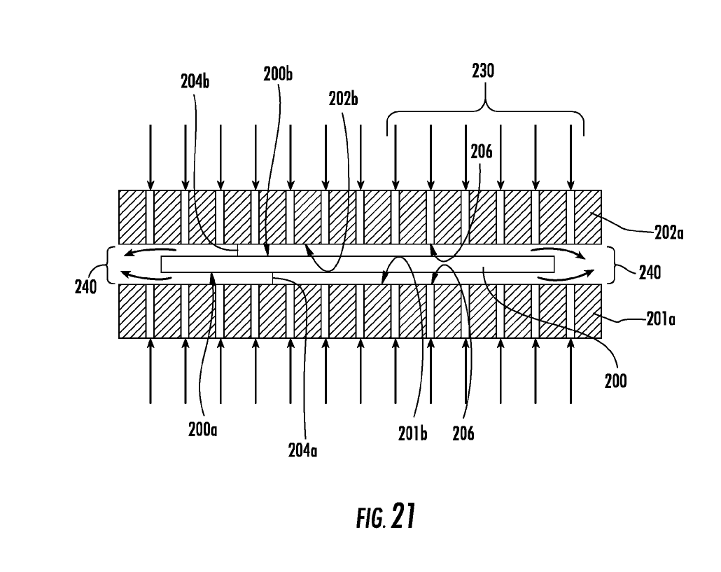

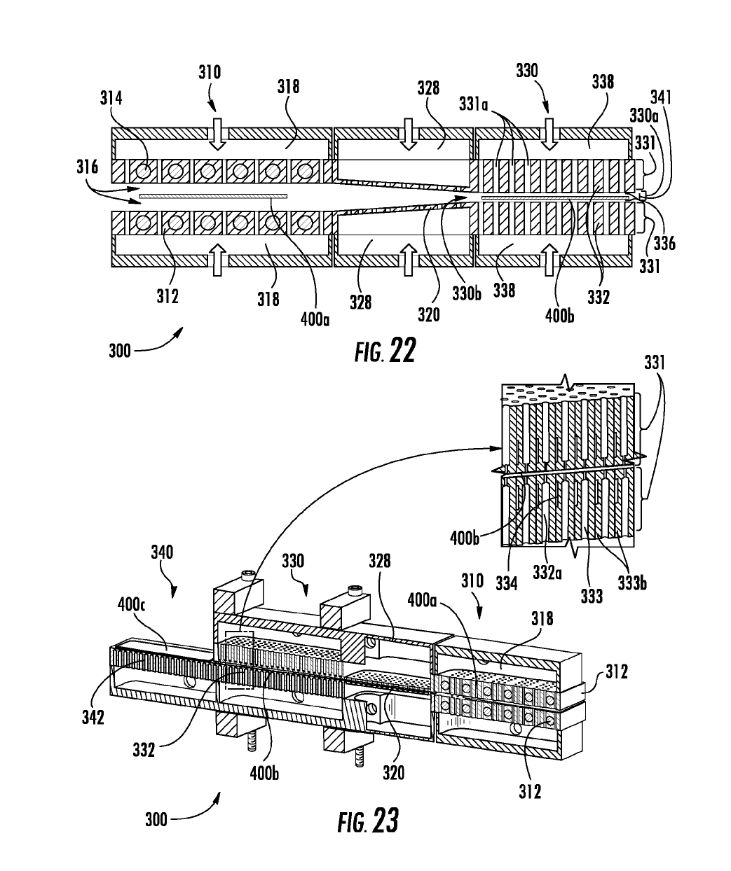

Referring now to FIG. 8 and FIG. 9, experiments were performed with 1.1 mm thick non-photochromic glass sheets of glass comprising at least 70% silicon dioxide by weight, and/or at least 10% sodium oxide by weight, and/or at least 7% calcium oxide by weight, and strengthened using the equipment and processes disclosed herein. As shown in FIG. 8, the number of granular chunks 616 per square centimeter of the glass has been found to be generally related to the magnitude of positive tensile stress at the center of the respective glass article 610. Similarly, as shown in FIG. 9, the fragmentation potential of the respective glass article 610 has also been found to be related to temperature of the glass in the hot zone (see e.g., FIG. 21, FIG. 22 and FIG. 23) and the calculated expected heat transfer coefficient (h) in units of cal/cm²·s·° C. (SI units watt/m²·° K) effectively applied to the glass surfaces during quenching, based on size of the gap between the glass sheet surfaces and the heat sink/gas bearing during quenching and on the thermal conductivity of the gas used in the gap. It is appreciated that the results shown in FIG. 8 and FIG. 9 illustrate thin glass sheet break performance behaviors that apply to thin photochromic glass sheets.

### Thermally Tempered Photochromic Glass Sheet Fictive Temperature

In various embodiments, the thermally strengthened photochromic glass sheets formed by the systems and methods discussed herein (e.g., photochromic glass sheet 500) have high fictive temperatures. It will be understood that in various embodiments, high fictive temperatures of the photochromic glass materials discussed herein relate to the high level of tempering, high central tensile stresses and/or high compressive surface stress of photochromic glass sheet 500. Surface fictive temperatures may be determined by any suitable method, including differential scanning calorimetry, Brillouin spectroscopy, or Raman spectroscopy.

According to an exemplary embodiment, the photochromic glass sheet 500 has a portion thereof, such as at or near the first and/or second surfaces 510, 520, that has a particularly high fictive temperature, such as at least 500° C., such as at least 600° C., or even at least 700° C. According to an exemplary embodiment, the photochromic glass sheet 500 has a portion thereof, such as at or near the first and/or second surfaces 510, 520, that has a particularly high fictive temperature relative to annealed photochromic glass of the same chemical composition, such as at least 10° C. greater, at least 30° C. greater, at least 50° C. greater, at least 70° C. greater, or even at least 100° C. greater. High fictive temperature may be achieved by the presently disclosed inventive technology at least in part due to the rapid transition from the hot to the cooling zones in the strengthening system (see e.g., FIG. 21, FIG. 22 and FIG. 23). Applicant believes that high fictive temperature may correspond or relate to increased damage resistance of photochromic glass.

In some methods of determining surface fictive temperatures, it may be necessary to break the photochromic glass to relieve the “temper stresses” induced by the heat strengthening process in order to measure fictive temperature with reasonably accuracy. It is well known that characteristic structure bands measured by Raman spectroscopy shift in a controlled manner both with respect to the fictive temperature and with respect to applied stress in borosilicate photochromic glasses. This shift can be used to non-destructively measure the fictive temperature of a thermally strengthened photochromic glass sheet if the temper stress is known.

Referring generally to FIG. 10, determination of fictive temperature for several non-photochromic glass articles is shown. Stress effects on the Raman spectrum of silica glass are reported in D. R. Tallant, T. A. Michalske, and W. L. Smith, “The effects of tensile stress on the Raman spectrum of silica glass,” J. Non-Cryst. Solids, 106 380-383 (1988). Commercial glasses of 65 wt. % silica or more have substantially the same response. Although the reported stress response is for uniaxial stress, in the case of a unibiaxial stress state such as that which is observed in tempered glass, σₓₓ=σ_{yy}, the peak can be expected to shift by twice that expected by a uniaxial stress. The peak near 1090 cm⁻¹ in soda-lime glass and in glass 2 corresponds to the 1050 cm⁻¹ peak observed in silica glass. The effects of stress on the 1050 cm⁻¹ peak in silica, and on the corresponding peak in SLG and other silicate glasses can be expressed, as a function of stress σ in MPa, by equation a) ω (cm⁻¹)=1054.93−0.00232·σ.

A calibration curve was produced of Raman band positions as a function of the fictive temperature for SLG and another glass, glass 2. Glass samples were heat-treated for various times, 2-3 times longer than the structural relaxation times calculated by τ=10*η/G, where η is the viscosity, and G the shear modulus. After heat-treatment, the glasses were quenched in water to freeze the fictive temperature at the heat-treatment temperature. The glass surfaces were then measured by micro Raman at 50× magnification and a 1-2 μm spot size using a 442 nm laser, 10-30 s exposure time, and 100% power, over the range of 200-1800 cm⁻¹. The position of the peak at 1000-1200 cm⁻¹ was fit using computer software, Renishaw WiRE version 4.1, in this case. A good fit of the 1090 cm⁻¹ Raman peak measured in SLG on the air side as a function of fictive temperature Tf (in ° C.) is given by equation b) ω (cm⁻¹)=1110.66−0.0282·Tf. For glass 2, a good fit is given by equation c) ω (cm⁻¹)=1102.00−0.0231·Tf.

Using the relationships established in equations a), b), and c), it is possible to express the fictive temperature of photochromic glass as a function of a measured Raman peak position with a correction factor due to surface compressive stress. A compressive stress of 100 MPa, σ_{c}, shifts the Raman band position equivalent to approximately a 15 to 20 degree Celsius reduction in the fictive temperature. The following equation is applicable to SLG:

$${T}_{f} ( ° C . ) = [ \frac{ω ( {cm}^{- 1} ) - 1110.66 ( {cm}^{- 1} )}{- 0.0282 ( \frac{{cm}^{- 1}}{° C .} )} ] + 2 [ 0.082 * {σ}_{c} ( MPa ) ] \qquad ( 1 )$$

The equation applicable to glass 2 is:

$${T}_{f} ( ° C . ) = [ \frac{ω ( {cm}^{- 1} ) - 1102 ( {cm}^{- 1} )}{- 0.0231 ( \frac{{cm}^{- 1}}{° C .} )} ] + 2 [ 0.0996 * {σ}_{c} ( MPa ) ] \qquad ( 2 )$$

In these equations, ω is the measured peak wavenumber for the peak near 1090 cm⁻¹, σ_{c} is the surface compressive stress measured by any suitable technique, yielding stress-corrected measurement of fictive temperature in ° C. As a demonstration of increased damage resistance related to the determined fictive temperature, four glass sheet samples were prepared, two 6 mm soda-lime glass (SLG) sheets by conventional tempering methods to approximately 70 and 110 MPa surface compressive stress (CS), and two 1.1 mm SLG sheets by the methods and systems disclosed herein to about the same levels of CS. Two additional sheets, one of each thickness were used as controls. The surfaces of each test sheet were subjected to standard Vickers indentation. Various levels of force were applied, for 15 seconds each, and after a 24 hour wait, indentations were each examined. As shown in Table I, the 50% cracking threshold (defined as the load at which the average number of cracks appearing is two out of the four points of the indenter at which cracks tend to initiate) was determined for each sample.

Table I shows that the Vickers crack initiation threshold for SLG processed by conventional convective gas tempering (as reflected in the 6 mm sheet) is essentially the same as that for annealed or as-delivered SLG sheets, rising from between zero and one newton (N) to about one to less than two newtons. This correlates with the relatively modest rise in surface fictive temperature (T_{fs} or Tf_{surface}) of ˜25 to 35° C. relative to glass transition temperature (T_{g}=550° C. for SLG, defined as η=10^{12-13.3} Poise) that was provided by conventional tempering. In contrast, by tempering using the present methods and systems (as reflected in the 1.1 mm sheet), the Vickers crack initiation threshold improved to greater than 10 N, a 10-fold increase over the Vickers damage resistance imparted by conventional tempering. In the embodied glasses, the T_{fs} minus T_{g} was at least 50° C., or at least 75° C., or at least 90° C., or in the range of from approximately 75° C. to 100° C. Even in embodiments comprising lower levels of heat strengthening, the embodied glasses can still provide increased resistance, at levels such as 5 N, for instance. In certain contemplated embodiments, the 50% cracking threshold after a 15 second Vickers crack initiation test may be equal to or greater than 5 N, 10 N, 20 N, or 30 N.

TABLE I

| | | | | Cracking |
|---|---|---|---|---|
| | Thickness | CS | Surface T_{f} | Threshold |
| Sample | (mm) | (MPa) | (° C.) | (N) |
| Control | 1.1 | Annealed | ~T_{g} (550) | 0-1 |
| Control | 6 | Annealed | ~T_{g} (550) | 0-1 |
| Thin low strength | 1.1 | −72 | 626 | 10-20 |
| Thick low strength | 6 | −66 | 575 | 1-2 |
| Thin medium strength | 1.1 | −106 | 642 | 10-20 |
| Thick medium strength | 6 | −114 | 586 | 1-2 |

The following non-dimensional fictive temperature parameter θ can be used to compare the relative performance of a thermal strengthening process in terms of the fictive temperature produced. Given in terms of surface fictive temperature θs in this case:

θs=(T_{fs}−Tₐₙₙₑₐₗ)/(T_{soft}−Tₐₙₙₑₐₗ) (3)

where T_{fs} is the surface fictive temperature, Tₐₙₙₑₐₗ (the temperature of the glass at a viscosity of η=10^{13.2} Poise) is the annealing point and T_{soft} (the temperature of the glass at a viscosity of η=10^{7.6} Poise) is the softening point of the glass of the sheet. FIG. 10 is a plot of θs for measured surface fictive temperatures as a function of heat transfer rate, h, applied during thermal strengthening for two different glasses. As shown in FIG. 10, the results for the two different glasses overlie each other fairly closely. This means that parameter θ provides a means to compare the fictive temperatures of different glasses compared directly, in relation to the heat transfer rate h required to produce them. The vertical range of results at each h corresponds to variation in the value of T₀, the initial temperature at the start of quenching. In embodiments, parameter θs comprises from about (e.g., plus or minus 10%) 0.2 to about 0.9, or 0.21 to 0.09, or 0.22 to 0.09, or 0.23 to 0.09, or 0.24 to 0.09, or 0.25 to 0.09, or 0.30 to 0.09, or 0.40 to 0.09, or 0.5 to 0.9, or 0.51 to 0.9, or 0.52 to 0.9, or 0.53 to 0.9, or 0.54 to 0.9, or 0.54 to 0.9, or 0.55 to 0.9, or 0.6 to 0.9, or even 0.65 to 0.9.

### Thermally Tempered Photochromic Glass Sheet Temperability Parameter

In various embodiments, the thermally strengthened glass sheets and particularly thermally strengthened photochromic glass sheets formed by the systems and methods discussed herein (e.g., photochromic glass sheet 500) have a high temperability and/or heat transfer value. The “specific thermal stress” of a glass is given by:

$$\frac{α \cdot E}{1 - μ} \qquad ( 4 )$$

where α is the (low temperature linear) CTE of the glass, E is the modulus of elasticity of the glass material and μ is Poisson's ratio of the glass material. This value is used to indicate the level of stress produced within a given glass composition, e.g. a given photochromic glass composition, when subjected to a temperature gradient. It may also be used as an estimator of thermal “temperability.” At higher thermal transfer rates (such as at about 800 W/m²K and above, for example), however, the high temperature or “liquidus” CTE of the glass begins to affect tempering performance. Therefore, under such conditions, the temperability parameter Ψ, based on an approximation of integration over the changing CTE values across the viscosity curve, is found to be useful:

Ψ=E·[Tₛₜᵣₐᵢₙ·α_{CTE}^{s}+α_{CTE}^{L}·(T_{soft}−Tₛₜᵣₐᵢₙ)] (5)

where α_{CTE}^{s} is the low temperature linear CTE (equivalent to the average linear expansion coefficient from 0-300° C. for the glass), expressed in 1/° C. (° C.⁻¹), α_{CTE}^{L} is the high temperature linear CTE (equivalent to the high-temperature plateau value which is observed to occur somewhere between the glass transition and softening point), expressed in 1/° C. (° C.⁻¹), E is the elastic modulus of the glass, expressed in GPa (not MPa) (which allows values of the (non-dimensional) parameter Ψ to range generally between 0 and 1), Tₛₜᵣₐᵢₙ is the strain point temperature of the glass, (the temperature of the glass at a viscosity of η=10^{14.7} Poise) expressed in ° C., and T_{soft} is the softening point of the glass (the temperature of the glass at a viscosity of η=10^{7.6} Poise), expressed in ° C.

The thermal strengthening process and resulting surface compressive stresses were modeled for glasses having varying properties to determine the tempering parameter, Ψ. The glasses were modeled at the same starting viscosity of 10^{8.2} Poise and at varying heat transfer coefficients. The properties of the various glasses are shown in Table II, together with the temperature for each glass at 10^{8.2} Poise and the calculated value of the temperability parameter Ψ for each.

TABLE II

| | | | | 10^{8.2} | Softening | Strain | |
|---|---|---|---|---|---|---|---|
| | | CTE | CTE | Poise | Point | Point | |
| Glass | Modulus | low | high | ° C. | ° C. | ° C. | Ψ |
| SLG | 72 | 8.8 | 27.61 | 705 | 728 | 507 | 0.76 |
| 2 | 73.3 | 8.53 | 20.49 | 813 | 837 | 553 | 0.77 |
| 3 | 65.5 | 8.26 | 26 | 821 | 862 | 549 | 0.83 |
| 4 | 65 | 8.69 | 20.2 | 864 | 912 | 608 | 0.74 |
| 5 | 63.9 | 10.61 | 22 | 849 | 884 | 557 | 0.84 |
| 6 | 58.26 | 3.5 | 20.2 | 842 | 876 | 557 | 0.49 |
| 7 | 73.6 | 3.6 | 13.3 | 929 | 963 | 708 | 0.44 |
| 8 | 81.1 | 3.86 | 12.13 | 968 | 995 | 749 | 0.48 |

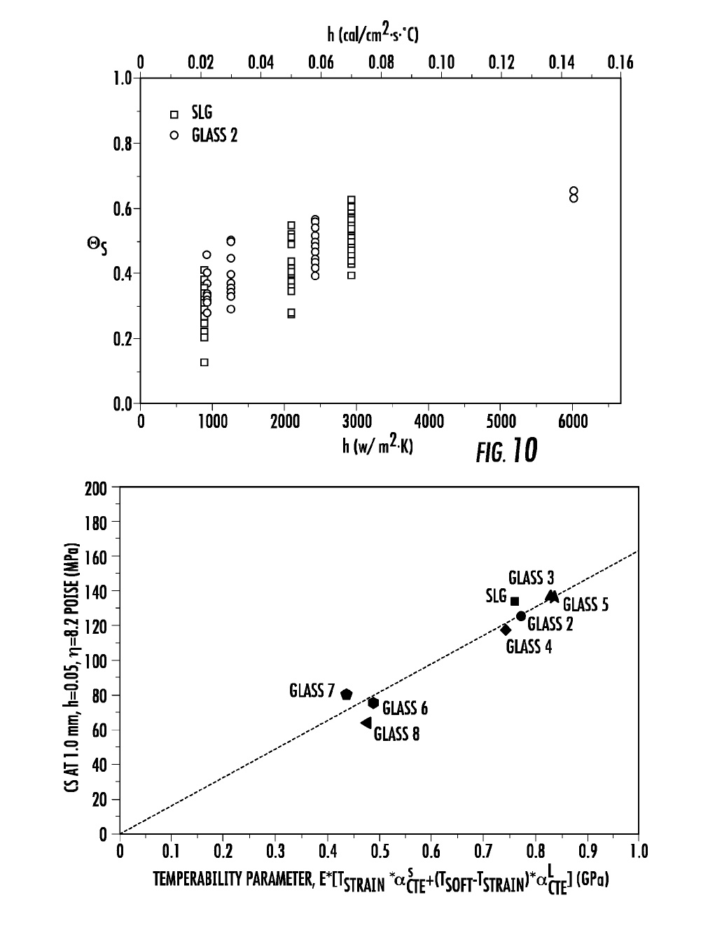

The results in Table II show that Ψ is proportional to the thermal strengthening performance of the glass. This correlation is further shown in FIG. 11, which provides an embodied example for a high heat transfer rate (a heat transfer coefficient of 2093 W/m²K (0.05 cal/s·cm²·° C.)) and a glass sheet thickness of only 1 mm. As seen in the figure, the variation in the seven differing glasses' resulting compressive stress correlates well with the variation in the proposed temperability parameter Ψ. It is appreciated that the correlation shown in FIG. 11 applies to photochromic glasses.

### Thermally Tempered Photochromic Glass Sheet Heat Transfer Coefficient and Relation to Surface Compressive Stress and Central Tension Stress

In another aspect, it has been found that for any glass, at any given value of the heat transfer coefficient, h (expressed in cal/cm²-s-° C.), the curves of surface compressive stress (α_{CS}, in MPa) vs. thickness (t, in mm) can be fit (over the range oft from 0 to 6 mm) by the hyperbola, where P₁ and P₂ are functions of h such that:

$${σ}_{CS} ( Glass , h , t ) = C ( h , t ) * Ψ ( Glass ) = \frac{{P}_{1} ( h ) * t}{( {P}_{2} ( h ) + t )} * Ψ ( Glass ) \qquad ( 6 )$$

or with the expression for Ψ substituted in, the curve of compressive stress σ_{CS}(Glass,h,t) is given by:

$$\frac{{P}_{1} ( h ) * t}{( {P}_{2} ( h ) + t )} \cdot E \cdot [ {T}_{strain} \cdot {α}_{CTE}^{s} + {α}_{CTE}^{L} \cdot ( {T}_{soft} - {T}_{strain} ) ] \qquad ( 7 )$$

where the constants P₁, P₂, in either (6) or (7) above, are each continuous functions of the heat transfer value, h, given by:

$$\begin{matrix}{P}_{1} = 910.2 - 259.2 \cdot exp ( - \frac{h}{0.143} ) and & ( 8 ) \\ {P}_{2} = 2.53 + \frac{23.65}{( 1 + {( \frac{h}{0.00738} )}^{1.58} )} & ( 9 )\end{matrix}$$

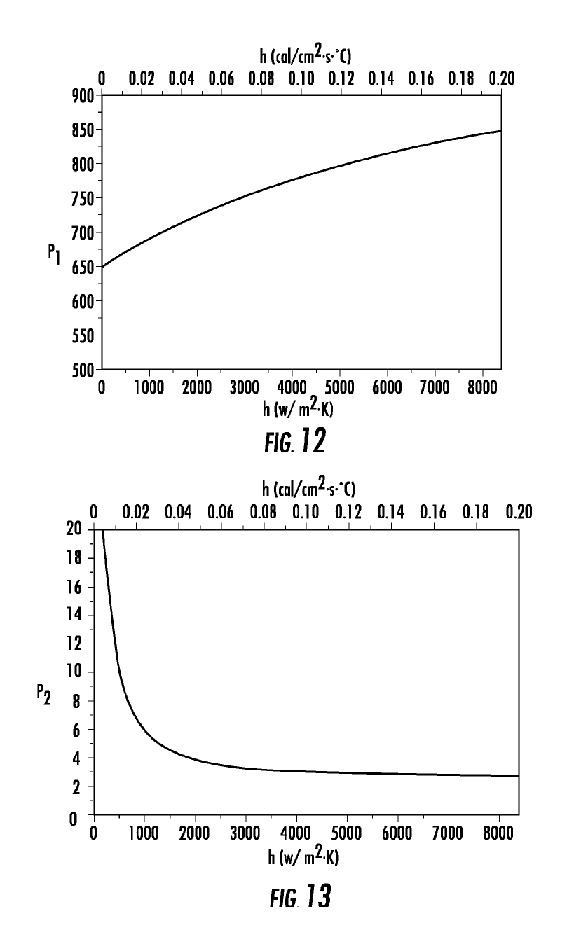

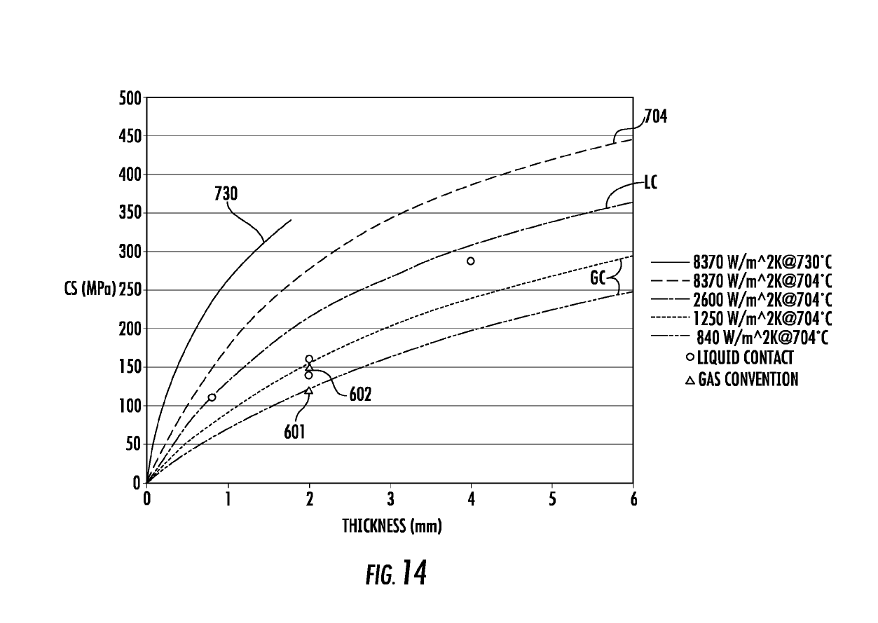

The constants P₁, P₂, are graphed as functions of h in FIGS. 12 and 13, respectively. Accordingly, by using a value of P₁, for a given h and the corresponding P₂, for that same h in expression (6) or (7) above, a curve is specified corresponding to the surface compressive stress (CS) obtainable at that h, as a function of thickness t.

In some embodiments, a similar expression may be used to predict the central tension (CT) of a thermally strengthened photochromic glass sheet, particularly at a thickness of 6 mm and less, and the thermal transfer coefficient, such as 800 W/m²K and up, by simply dividing the compressive stress predicted under the same conductions by 2. Thus, expected central tension may be given by

$$\frac{{P}_{1 CT} ( {h}_{CT} ) * t}{( {P}_{2 CT} ( {h}_{CT} ) + t )} \cdot E \cdot [ {T}_{strain} \cdot {α}_{CTE}^{s} + {α}_{CTE}^{L} \cdot ( {T}_{soft} - {T}_{strain} ) ] \qquad ( 10 )$$

Where P_{1CT} and P_{2CT} are given as follows:

$$\begin{matrix}{P}_{1 CT} = 910.2 - 259.2 \cdot exp ( - \frac{{h}_{CT}}{0.143} ) and & ( 11 ) \\ {P}_{2 CT} = 2.53 + \frac{23.65}{( 1 + {( \frac{{h}_{CT}}{0.00738} )}^{1.58} )} & ( 12 )\end{matrix}$$

In some embodiments, h and h_{CT}, may have the same value for a given physical instance of thermal strengthening. However, in some embodiments, they may vary, and providing separate variables and allowing variation between them allows for capturing, within descriptive performance curves, instances in which the typical ratio of 2:1 CS/CT does not hold.

One or more embodiments of the currently disclosed processes and systems have produced thermally strengthened SLG sheets at all of the heat transfer rate values (h and h_{CT}) shown in Table III.

TABLE III
h and h_{CT} values according to exemplary embodiments

| cal/s · cm² · ° C. | W/m²K |
|---|---|
| 0.010 | 418.68 |
| 0.013 | 544.284 |
| 0.018 | 753.624 |
| 0.019 | 795.492 |
| 0.020 | 837.36 |
| 0.021 | 879.228 |
| 0.022 | 921.096 |
| 0.023 | 962.964 |
| 0.027 | 1130.436 |
| 0.028 | 1172.304 |
| 0.029 | 1214.172 |
| 0.030 | 1256.04 |
| 0.031 | 1297.908 |
| 0.033 | 1381.644 |
| 0.034 | 1423.512 |
| 0.038 | 1590.984 |
| 0.040 | 1674.72 |
| 0.041 | 1716.588 |
| 0.042 | 1758.456 |
| 0.045 | 1884.06 |
| 0.047 | 1967.796 |
| 0.048 | 2009.664 |
| 0.049 | 2051.532 |
| 0.050 | 2093.4 |
| 0.051 | 2135.268 |
| 0.052 | 2177.136 |
| 0.053 | 2219.004 |
| 0.054 | 2260.872 |
| 0.055 | 2302.74 |
| 0.060 | 2512.08 |
| 0.061 | 2553.948 |
| 0.062 | 2595.816 |
| 0.063 | 2637.684 |
| 0.065 | 2721.42 |
| 0.067 | 2805.156 |
| 0.069 | 2888.892 |
| 0.070 | 2930.76 |
| 0.071 | 2972.628 |
| 0.078 | 3265.704 |
| 0.080 | 3349.44 |
| 0.081 | 3391.308 |
| 0.082 | 3433.176 |
| 0.095 | 3977.46 |
| 0.096 | 4019.328 |
| 0.102 | 4270.536 |
| 0.104 | 4354.272 |
| 0.105 | 4396.14 |
| 0.127 | 5317.236 |
| 0.144 | 6028.992 |
| 0.148 | 6196.464 |
| 0.149 | 6238.332 |
| 0.184 | 7703.712 |

In some embodiments, the heat transfer value rates (h and h_{CT}) may be from about 0.024 to about 0.15, about 0.026 to about 0.10, or about 0.026 to about 0.075 cal/s·cm²·° C.

FIG. 14 shows the newly opened performance space in MPa of surface compression of glass sheet as a function of thickness t (in mm), by a graph of C(h,t)·Ψ(SLG) for selected values of h according to equations 6-9 above, with Ψ(SLG) corresponding to the value of Ψ for SLG in Table II. The traces labeled GC represent the estimated range of maximum stresses versus thinness of SLG sheets achievable by gas convective tempering, from 0.02 cal/s·cm²·° C. (or 840 W/m²K) to 0.03 cal/s·cm²·° C. or 1250 W/m²K, assuming that these levels of heat transfer coefficient can be employed in that process at a heated glass viscosity of 10^{8.2} Poises or about 704° C., a temperature above the capability of convective gas processes.

Examples of highest reported sheet CS values based on gas convective tempering processes are shown by the triangle markers labeled Gas in the legend. The value 601 represents advertised product performance capability of commercial equipment, while the value 602 is based on an oral report at a glass processing conference. The trace labeled LC represents the curve of maximum stresses versus thinness of SLG sheets estimated to be achievable by liquid contact tempering, given by a heat transfer rate h of 0.0625 cal/s·cm²·° C. (or about 2600 W/m²K), also assuming processing at an initial heated glass viscosity of 10^{8.2} Poises or about 704° C. Examples of highest reported sheet CS values based on liquid contact tempering processes are shown by the circle markers labeled Liquid in the legend. The higher of the two values at 2 mm thickness is based on a report of tempering of a borosilicate photochromic glass sheet, and the stress achieved has been scaled for the figure by (Ψ_{SLG})/(Ψ_{borosilicate}) for scaled direct comparison.

The trace labeled 704 represents stresses achievable by one or more embodiments of the presently disclosed methods and systems at a heat transfer rate of 0.20 cal/s·cm²·° C. (or about 8370 W/m²K) and an initial temperature, just before quenching, of 704° C. The level of stress on the photochromic glass sheet thus achievable represents almost the same scope of improvement over liquid tempering strength levels as liquid tempering represents over state of the art gas convective tempering. But the trace labeled 704 is not an upper limit—embodiments have been shown to be viable above this value due to the good control of form and flatness achievable in a small-gap gas bearing thermal strengthening at even higher temperatures (at lower viscosities of the photochromic glass). The trace labeled 730 shows some of the additional strengthening performance achieved by a heat transfer rate of 0.20 cal/s·cm²·° C. (or about 8370 W/m²K) at a starting temperature for a SLG sheet of 730° C., very near or above the softening point of the photochromic glass. Significant improvements in compressive stress and thus in photochromic glass sheet strength are thus achieved particularly by the combination of high heat transfer rate and the use of high initial temperatures enabled by the good handling and control of sheet flatness and form in a tight gas bearing—and the improvements are particularly striking at thickness 2 mm and below. It is appreciated that similar surface compression values as illustrated by trace 704 and trace 730 in FIG. 14 are available for photochromic glass sheet.

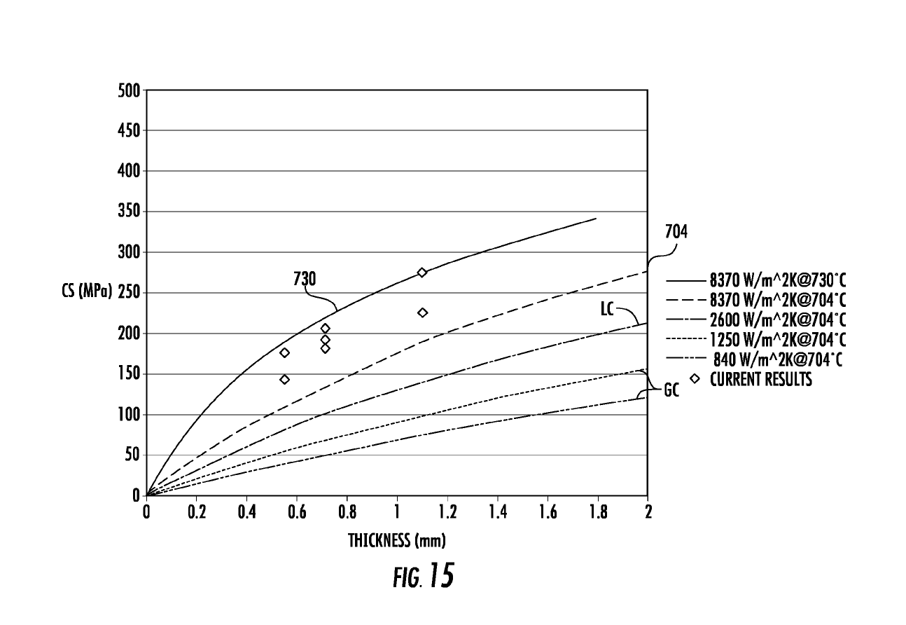

FIG. 15 shows the traces of FIG. 14 explained above, at 2 mm and below, but with compressive stress as a function of thickness plotted for selected examples of tempered glass sheets produced by one or more embodiments of the present disclosure, showing the extreme combination of thermal strengthening levels and thinness enabled by the present disclosure. It is appreciated that similar surface compression values as illustrated by trace 704 and trace 730 in FIG. 15 are available for photochromic glass sheet.

### Thermally Tempered Photochromic Glass Sheet with Low Surface Roughness and High Degree of Flatness

In various embodiments, thermally strengthened photochromic glass sheets disclosed herein, such as sheet 500, have both high thermal stresses and low, as-formed surface roughness. The processes and methods disclosed herein can thermally strengthen a sheet of photochromic glass without increasing the surface roughness of the as-formed surfaces. For example, incoming float photochromic glass air-side surfaces and incoming fusion formed photochromic glass surfaces were characterized by atomic force microscopy (AFM) before and after processing. Rₐ surface roughness was less than 1 nm (0.6-0.7 nm) for incoming 1.1 mm float photochromic glass, and the Rₐ surface roughness was not increased by thermal strengthening according to the present processes. Similarly, an Rₐ surface roughness of less than 0.3 nm (0.2-0.3) for 1.1 mm sheets of fusion-formed photochromic glass was maintained by thermal strengthening according to this disclosure. Accordingly, thermally strengthened photochromic glass sheets have a surface roughness on at least a first surface in the range from 0.2 to 1.5 nm Rₐ roughness, 0.2 to 0.7 nm, 0.2 to 0.4 nm or even such as 0.2 to 0.3 nm, over at least an area of 10×10 μm. Surface roughness may be measured over an area of 10×10 μm in exemplary embodiments, or in some embodiments, 15×15 μm. For float glass, in embodiments, surface roughness of less than 0.15 micrometer per 20 mm length, peak-to-peak, for 1.1 mm substrates, and less than 0.20 micrometer per 20 mm length, peak-to-peak, for 0.7 mm substrates are provided for thermally strengthened photochromic glass sheets disclosed herein. In other embodiments, surface roughness of less than 0.05 micrometer per 20 mm length, peak-to-peak, for 1.1 mm substrates, and less than 0.075 micrometer per 20 mm length, peak-to-peak, for 0.7 mm substrates are typical for thermally strengthened photochromic glass sheets disclosed herein.

In some contemplated embodiments, thermally strengthened photochromic glass sheets disclosed herein have both high thermal stresses and low, as-formed surface roughness and/or coated surfaces. The processes and methods disclosed herein can thermally strengthen a sheet of photochromic glass without increasing the surface roughness of smooth as-formed or as-delivered surfaces of photochromic glass sheets, and likewise without damaging sensitive low-E or anti-reflective or other coatings. Incoming float photochromic glass air-side surfaces, and incoming fusion-formed photochromic glass surfaces, were characterized by atomic force microscopy (AFM) before and after processing. Rₐ surface roughness was less than 1 nm (such as 0.6 to 0.7 nm) for incoming on the air side of 1.1 mm soda-lime float photochromic glass and was not increased by thermal strengthening according to the present disclosure. Rₐ surface roughness was less than 0.3 nm (such as 0.2 to 0.3 nm) incoming on 1.1 mm sheets of fusion-formed photochromic glass and likewise was not increased by thermal strengthening according to this disclosure. Accordingly, in contemplated embodiments, thermally strengthened photochromic glass sheets, according to this disclosure, have surface roughness on at least a first surface in the range of at least 0.2 nm and/or no more than 1.5 nm Rₐ roughness, such as no more than 0.7 nm, such as no more than 0.4 nm or even such as no more than 0.3 nm, or have thermally strengthened sheets having coatings thereon of the type that may be applied before strengthening, or have combinations of these low roughness values and coatings, are obtained from the present process used with corresponding photochromic glass sheets as starting material. It is Applicant's understanding that such preservation of surface quality and/or surface coating(s) previously required use of convective gas tempering or perhaps a low heat transfer liquid tempering process, which produces limited thermal strengthening effects relative to the total range available with the present processes and methods.

In another embodiment, the thermally strengthened photochromic glass sheets described herein have high flatness. In various embodiments, the strengthening system discussed herein utilizes controlled gas bearings to support the photochromic glass material during transporting and heating, and in some embodiments, can be used to assist in controlling and/or improving the flatness of the photochromic glass sheet, resulting in a higher degree of flatness than previously obtainable, particularly for thin and/or highly strengthened photochromic glass sheets. For example, sheets at least 0.6 mm can be strengthened with improved post-strengthening flatness. The flatness of thermally strengthened photochromic glass sheets embodied herein can comprise 100 μm or less total indicator run-out (TIR) along any 50 mm length along one of the first or second surfaces thereof, 300 μm TIR or less within a 50 mm length on one of the first or second surfaces, 200 μm TIR or less, 100 μm TIR or less, or 70 μm TIR or less within a 50 mm length on one of the first or second surfaces. In exemplary embodiments, flatness is measured along any 50 mm or less profile of the photochromic glass sheet. In contemplated embodiments, sheets with thickness disclosed herein have flatness 200 μm TIR or less within a 20 mm length on one of the first or second surfaces, such as flatness 100 μm TIR or less, flatness 70 μm TIR or less, flatness 50 μm TIR or less.

According to contemplated embodiments, the strengthened photochromic glass articles discussed herein (e.g., photochromic glass sheet 500 shown in FIG. 4) have a high-degree of dimensional consistency such that the thickness t thereof along a 1 cm lengthwise stretch of the body 522 does not change by more than 50 μm, such as, by not more than 10 μm, not more than 5 μm, not more than 2 μm. Such dimensional consistency may not be achievable for given thicknesses, areas, and/or magnitudes of negative tensile stress, as disclosed herein, by solid quenching due to practical considerations, such as cooling plate alignment and/or surface irregularities that may distort the dimensions.

According to contemplated embodiments, the strengthened photochromic glass articles discussed herein have at least one major surface (e.g., first and second surfaces 510, 520 of the strengthened photochromic glass sheet 500 in FIG. 4) that is flat such that a 1 cm lengthwise profile therealong stays within 50 μm of a straight line, such as within 20 μm, 10 μm, 5 μm, 2 μm; and/or a 1 cm widthwise profile therealong stays within 50 μm of a straight line, such as within 20 μm, 10 μm, 5 μm, 2 μm. Such high flatness may not be achievable for given thicknesses, areas, and/or magnitudes of negative tensile stress, as disclosed herein, by liquid quenching due to practical considerations, such as warping or bending of the photochromic glass strengthened in these processes due to convective currents and associated forces of the liquid.

Photochromic glass sheets formed according to the present disclosure have a multitude of applications, for example in eye glasses, industrial applications such as sensors and novelty items such as toys. Stronger and thinner laminates can be produced, resulting in weight and cost savings and fuel efficiency increases. Desirably, a thermally strengthened thin sheet may be cold bent and laminated to a formed thicker photochromic glass, providing an easy and reliable manufacturing process not requiring any hot forming of the thin sheet.

### Alpha of Thermally Tempered Photochromic Glass Sheet

Table IV below shows results on SLG obtained by the methods of the present disclosure (indicated as “Source of Method” I in the table), and a figure of merit, Alpha, that is a rough measure of the coefficient of heat exchange obtained within the tempering process. Alpha is given by:

$$Alpha = \frac{CS}{( t \cdot CTE \cdot E )} \qquad ( 13 )$$

where CS is physical compressive stress (in MPa), t is thickness in millimeters, CTE is the coefficient of thermal expansion in ° C.⁻¹, and E is the elasticity of the glass in (MPa), and yields units in ° C./mm.

TABLE IV

| Sample | Source of | | Thickness | CS | CTE | E | Alpha |
|---|---|---|---|---|---|---|---|
| No. | Method | Glass | (mm) | (MPa) | (1/C.) | (MPa)** | (C./mm) |
| 1 | I | SLG | 1.84 | 150 | 9.20E−06 | 68900 | 129 |
| 2 | I | SLG | 1.84 | 172 | 9.20E−06 | 68900 | 147 |
| 3 | I | SLG | 1.07 | 190 | 9.20E−06 | 68900 | 280 |

Samples 1 and 3 are repeatable values obtained from the disclosed processes, sample 1 using air and sample 3 using helium as the gas in the process. Sample 2 represents a “champion” value using air within the present process, that is, not reliably repeatable to date. Glass samples processed by the processes of the present disclosure (samples 1-3) all exceeded an Alpha at 117° C./mm. Applicant believes that the slope of Alpha with thickness may have an inherent trend lower with lower glass thickness. Glass disclosed herein has an Alpha of greater than 20t+77, where t is thickness of the glass, in mm, in some embodiments. It is appreciated that the results shown in Table IV can be obtained for photochromic glasses.

### Thermal Strengthening System and Process

In various embodiments, a process for strengthening a photochromic glass sheet comprises supporting or guiding at least a portion of a photochromic glass sheet, such as photochromic glass sheet 500, into a cool or quenching zone in which the sheet is rapidly cooled creating a strengthened photochromic glass sheet having one or more of the properties discussed herein. In various embodiments, the photochromic glass sheet is supported at least in part by a flow or a pressure of a gas delivered to a gap between the surfaces of the photochromic glass sheet and one or more heat sinks. In general, the temperature of the photochromic glass sheet is above the transition temperature of the photochromic glass when the sheet is moved into the cool zone, and in various embodiments, the photochromic glass sheet is cooled within the cooling zone by thermal conduction more than by convection. Crystals of silver halide are precipitated within the photochromic glass when the temperature of the photochromic glass sheet is above the transition temperature of the photochromic glass. Conduction is a process of heat transfer where energy is transmitted through interactions between adjacent molecules, and convection is a process of heat transfer where energy is communicated via motion of a fluid (e.g., air, helium, etc.), such as where heated fluid moves away from a heat source and is replaced by cooler fluid. Thus, the present system is markedly different from conventional convection-based glass strengthening/tempering systems in which the primary mode of heat transfer during cooling of the glass sheet is convective.

In some embodiments, an overall process for strengthening a photochromic glass sheet comprises heating a photochromic glass sheet in a hot zone and then cooling the photochromic glass sheet in a cooling zone. The photochromic glass sheet has a transition temperature, which is the temperature at which the viscosity of the photochromic glass has a value of η=10¹²-10^{13.3} Poise. The photochromic glass is heated sufficiently to bring the photochromic glass sheet above the transition temperature, and then moved into a cooling zone. Optionally, the photochromic glass can be transitioned from the hot zone to a cool zone through a transition zone. The photochromic glass sheet is held above the transition temperature for times sufficient for crystals of silver halide to precipitate within the photochromic glass sheet. In embodiments, the hot zone controls the temperature of the photochromic glass sheet to within 2° C. of a desired temperature and thereby ensures precipitation of silver halide crystals within a predetermined range of diameters and densities. In the cooling zone, the surfaces of the photochromic glass sheet are positioned adjacent to heat sinks, one on either side of the photochromic glass sheet, each with a gap in between one of the photochromic glass surfaces and an opposing surface of the heat sink. Gas is delivered into the gaps through multiple apertures in the heat sinks, and in some embodiments, this delivered gas forms an air bearing which supports the photochromic glass between the heat sinks such that the photochromic glass surfaces are not in contact with the heat sinks. Within the cooling zone, the photochromic glass sheet is cooled by conduction more than by convection and is cooled sufficiently to fix or create a thermally induced surface compression and a thermally induced central tension of the sheet which provides the increased strength as discussed herein. In various embodiments, primarily cooling via conduction is achieved by having a very low gap size within the cooling zone such that the photochromic glass sheet is close to, but not touching, the opposing surfaces of the heat sinks.

An apparatus for enabling the processes described can include a heating zone for heating a photochromic glass sheet to a temperature above the transition temperature and a cooling zone for cooling the heated photochromic glass sheet to provide a strengthened photochromic glass sheet. The apparatus can include an optional transition zone between the heating zone and the cooling zone. The cooling zone may include a heat sink having a pair of opposing surfaces defining a gap, within which the heated photochromic glass sheet is received. The cooling zone can comprise a pair of gas bearings disposed on opposite sides of that gap that acts to support the photochromic glass sheet within the gap. The gap can be configured to cool the heated photochromic glass sheet by conduction more than by convection. In some embodiments, the gas bearings can include a plurality of apertures for delivering the gas to the gap, and the gas bearing surfaces act as the heat sinks, capable of conducting heat away from the heated photochromic glass sheet by conduction more than by convection.

Strengthening processes and equipment disclosed herein (see generally FIGS. 21-25) allow for strengthening of photochromic glass articles (see generally FIGS. 4-7 and 27-28) by an inventive form of thermal tempering. The processes allow for steep, tensile stress versus thickness/depth curves (see generally FIG. 6), particularly steep in slope near the surface of the photochromic glass articles, which enable strengthening of the photochromic glass articles to particularly high levels of negative tensile stress for a given thickness near the surface of the respective articles, without requiring strengthening by ion-exchange or laminating photochromic glass to a different glass. However, in some embodiments, the thermal tempering processes disclosed herein may be augmented with ion-exchange or applied to glass-to-glass laminations. The thermal tempering processes disclosed herein enable particularly high levels of strengthening in large-area articles (e.g., sheets) that may be too large for strengthening via conventional thermal tempering methods, such as due to alignment limitations of contact quench equipment, cooling rate limitations of conventional convection systems, and/or warping damage associated with liquid quench tempering. The processes disclosed herein uniquely allow high levels of strengthening in particularly thin sheets that may be too thin for strengthening via conventional tempering methods, such as due to sensitivity to breakage or fracture of the thin photochromic glass articles during the strengthening process and associated contact forces with solid or liquid quenching and/or due to the cooling rate limitations of conventional convection tempering. However, in other contemplated embodiments, photochromic glass articles as disclosed herein may be manufactured with at least some solid or liquid quenching, such as in combination with the unique strengthening processes disclosed herein.

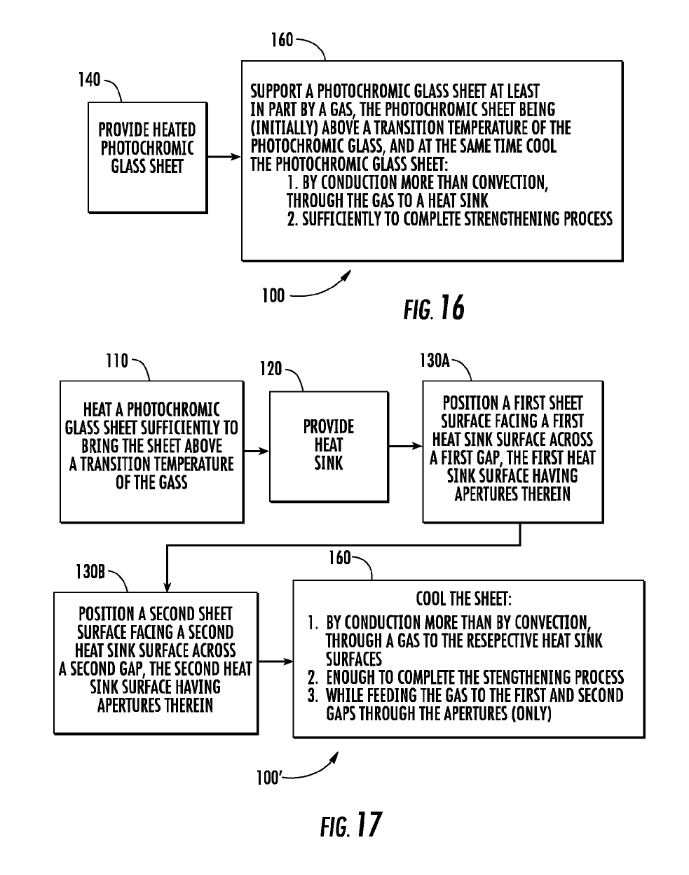

One embodiment of a method according to this disclosure is illustrated in the flow chart of FIG. 16. The method or process 100 includes a step 140 of providing a photochromic glass sheet that is at a temperature above a transition temperature of the photochromic glass sheet. The method or process 100 also includes the step 160 of supporting a photochromic glass sheet at least in part by a gas (through gas flow and pressure). Step 160 includes, while the photochromic glass sheet is support by the gas, cooling the sheet: 1) by conduction more than by convection through the gas to a heat sink; and 2) sufficiently to create or fix a thermally-induced surface compression stress and a thermally-induced central tension stress in the photochromic glass sheet when at ambient temperature.

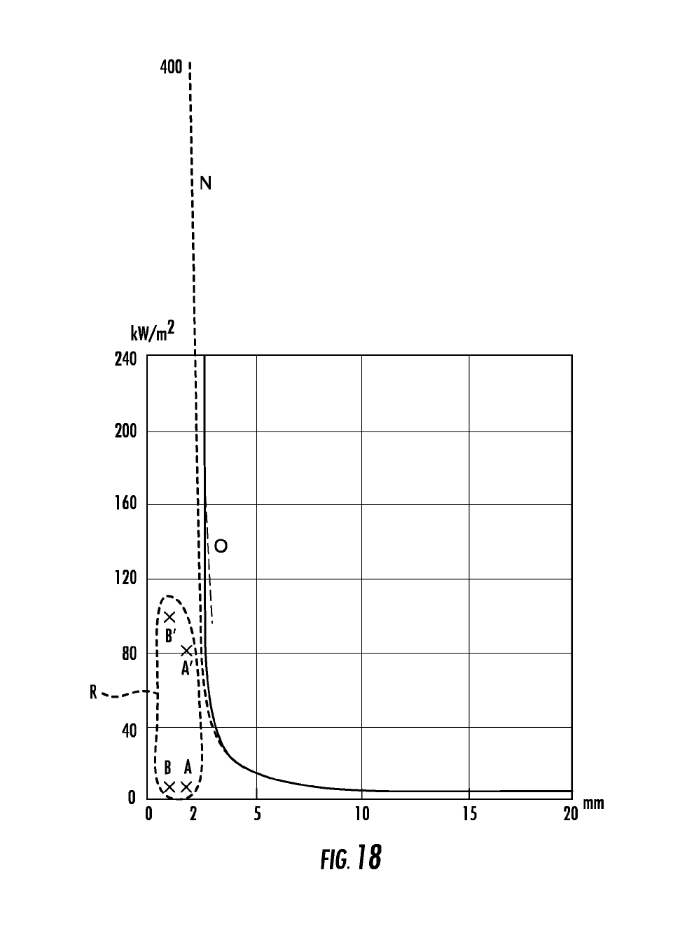

According to a variation on the embodiment of FIG. 16, depicted as method 100′ in the flow chart of FIG. 17, the method can include the step 110 of heating a photochromic glass sheet sufficiently such that the photochromic glass sheet is above a transition temperature of the photochromic glass. As part of, or as preparation for, the cooling step 160, the method 100′ further comprises, in step 120, providing a heat sink (whether as a single piece or in separate pieces) having first and second heat sink surfaces (see generally FIGS. 21-25), each having apertures therein. In step 130A the method further includes positioning a first sheet surface facing a first heat sink surface across a first gap and, in step 130B, positioning the second sheet surface facing a second heat sink surface across a second gap. The heat sink surfaces can include apertures and/or can be porous. The method 100′ can further include, in step 160, cooling the photochromic glass sheet, by conduction more than by convection through a gas to the respective heat sink surfaces, sufficiently to strengthen the photochromic glass sheet (e.g., to sufficiently create or fix in the sheet a thermally-induced surface compression stress and a thermally-induced central tension stress). The step 160 also can include delivering the gas to the first and second gaps through the apertures or porous heat sink, and in some such embodiments, the gas is delivered to form air bearings that support the photochromic glass sheet adjacent the heat sinks. In some embodiments, the gas is delivered only through the apertures of the heat sink, or only through the pores of a porous heat sink, or through the pores and apertures of a porous heat sink.

These and other related methods of this disclosure go against the currently dominant technique of gas-convection-cooling by using conduction as the dominant mode of cooling, instead of convection. Instead of a solid-to-gas (glass to air) heat exchange, methods described herein use a solid-to-solid (glass to heat sink) heat exchange, mediated across a small gap by a small amount of gas (e.g., without physical contact between glass surfaces and heat sink), both to begin and to complete the cooling that produces thermal strengthening. Although some convection is present as gas (e.g., air bearing gas) flows into the small gap, conduction directly across the gap through the gas and into the heat sink is the principal mode of cooling. Applicant has determined that dominance of conductive heat transfer increases the rate of heat transfer relative to convection dominant cooling processes.

Because solid-to-solid conduction (even across the gap) allows for more rapid heat flow than convection, the cooling rate increases needed for thinner photochromic glass sheets are not tied to gas velocity and volume. According to various embodiments, without the constraints typically imposed by gas flow and gap size in a convective system, gas flow and gap size can be selected, controlled or optimized for other purposes, such as for controlling stiffness of the gas cushion in the gap, for supporting the sheet, for flattening or otherwise shaping a sheet, for optimizing heat conduction, for maintaining sheet flatness and/or shape during thermal strengthening, and/or for balancing ease of sheet handling with high cooling rates. For example, in some embodiments, because cooling is not via convection, helium becomes an economically viable alternative to air in the system of the present disclosure due to the very low gas flow rates that support the gas bearing, and in such embodiments, helium offers thermal conductivity about five times that of air. Even helium with prices assumed at multiples of those available today becomes an economically viable alternative at the low flow rates of the system of the present disclosure.

Further, because the system of the present disclosure decreases the volume of gas flowing over a photochromic glass sheet during cooling (relative to convective systems), the systems and methods discussed herein decrease the potential risk of deformation of hot thin sheets of photochromic glass typically caused by the high speed, high volume air flows needed in conventional convection based tempering systems. This also allows softer, higher temperature photochromic glass sheets to be handled with no or minimal distortion, further improving the achievable degree of strengthening. Eliminating high gas flow rates also eases problems sometimes seen in transporting the sheet into the quenching chamber (moving against the high gas flow) and in keeping the high-flow, cooler gas from entering into and cooling the adjacent parts of the furnace used to heat the sheet.

Further the use of conduction, through a gas, may mitigate contact damage, warping, shaping, etc. associated with conventional liquid contact or solid contact quench tempering. Use of a gas as an intermediate conductor preserves the surface quality of the processed articles by avoiding solid-to-solid contact. Mediating the high conduction rates through a gas also avoids liquid contact. Some types of liquid quenching can introduce unwanted distortions, spatial variation in tempering and contamination of the photochromic glass surfaces. These embodiments essentially provide non-contact (except by a gas) but very high-rate cooling. In other embodiments, as discussed above, solid- or liquid-contact may be included.

### Power Consumption of Thermal Tempering System/Process

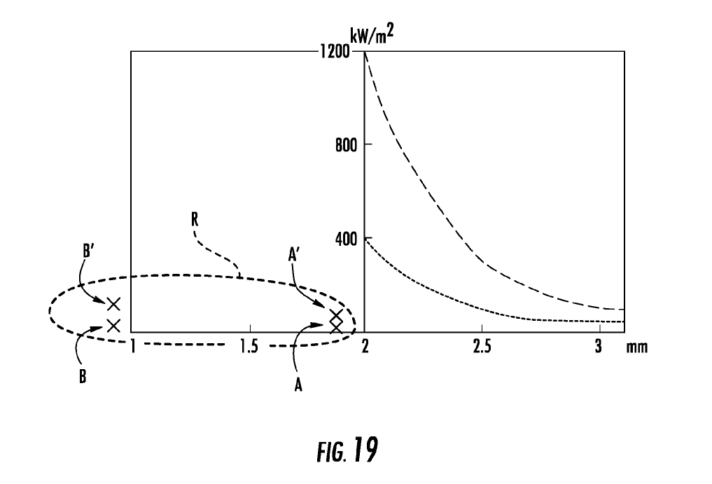

Another advantage of avoiding high air flow rates lies in the power and energy savings achieved by using solid-gas-solid conduction as the primary photochromic glass cooling mechanism. Points A and B of FIG. 18 and FIG. 19 represent a high-end estimate of peak power use of the air bearing, per square meter of photochromic glass sheet, by a compressed air supply at relatively high flow. Practical low-end peak power use of compressed air could be as little as 1/16 of the values shown. Points A and B do not include active cooling of the heat sink, however, which can be included in some embodiments, especially where a machine is in continuous, quasi-continuous or high frequency operation.

Referring again to FIG. 18 and FIG. 19, points A′ and B′ represent the conservatively estimated peak power levels for operation of the air bearing at points A and B when active cooling of the heat sink surfaces is factored in, assuming the thermal load equivalent of a 300° C. drop in photochromic glass sheet temperature is accomplished by an active cooling system having a thermal-to-mechanical (or electrical) efficiency ratio of 7.5 to 1, within a time limit of 2.1 seconds for point A′ and within 1 second for point B′. These points correspond approximately to photochromic glass sheets actually tempered in the apparatus described herein.

Although the four points within region R of FIG. 18 and FIG. 19 illustrate the significance of the improvement obtainable by the methods and systems of the present disclosure (at least to some degree), it should be noted that the full benefits are likely significantly understated in the figures because power demand is the quantity represented. For example, peak power of air blowers, as represented by the curve N, is not efficiently turned on and off, typically requiring gated airways to block off large fans, which still rotate (but at reduced load), when air is not needed. Peak power demands of fluid cooling systems such as chilled water plants, represented by the points A′ and B′ as examples easily achievable according to the present disclosure, can generally be much more efficiently accommodated, and effective peak power would be significantly lower, approaching A′ and B′ only as fully continuous operation is approached. Thus, the difference in total energy demands would tend to be greater than the difference for peak power demand, which is represented in the figure. In some embodiments, the processes described herein have peak powers of less than 120 KW/m², less than 100 KW/m², or less than 80 KW/m² to thermally strengthen a photochromic glass sheet of 2 mm thickness or less.

### Heat Transfer from Thin Photochromic Glass Sheet During Thermal Tempering

In general, heat transfer from the thin photochromic glass sheet in the system and process of the present disclosure includes a conduction component, a convection component and a radiant component. As noted above and explained in detail herein, the thermal tempering system of the present disclosure provides for thin photochromic glass tempering by utilizing conductive heat transfer as the primary mechanism for quenching the thin photochromic glass sheets.

The following is Applicant's understanding of the underlying theory. It may well occur to one of ordinary skill in the art of glass tempering, in which conduction effects are normally so small as to be commonly ignored in favor of analysis of convection and radiation alone, to ask whether sufficiently high cooling rates for thin photochromic glass sheets (such as at 2 millimeters and below) are actually achievable by conduction through a gas such as air—and if so, whether such rates are achievable at practical gap sizes.

The amount of thermal conduction at conditions embodied in processes using systems described herein can be determined via the following. First, in the context of thermal strengthening by conduction as in the present disclosure, the thermal conductivity of the gas within the gap must be evaluated in the direction of conduction, which is along a thermal slope. Air at high temperature, at or near the surface of the sheet being cooled, has significantly higher thermal conductivity than air at a lower temperature, such as air at or near room temperature at or near the surface of the heat sink (the nominal thermal conductivity of (dry) room temperature air (25° C.) is approximately 0.026 W/m·K). An approximation that assumes air over the whole gap to be at the average temperature of the two facing surfaces at the start of cooling is used. At the start of cooling, a photochromic glass sheet may be at a temperature of 670° C., for example, while the heat sink surface may start at 30° C., for example. Accordingly, the average temperature of the air in the gap would be 350° C., at which dry air has a thermal conductivity of about 0.047 W/m·K; more than 75% higher than its thermal conductivity at room temperature and sufficiently high to conduct large amounts of heat energy through gaps of the sizes within the system of the present disclosure, as discussed below, assuming the sheet is finished to a reasonably high degree of surface and thickness consistency.

To illustrate, Q_{cond}, the conductive component of the rate of heat transfer through a gap of distance g with an area A_{g} (in a direction everywhere perpendicular to the direction of the gap distance g) may be given by:

$${Q}_{cond} = \frac{{A}_{g} k ( {T}_{S} - {T}_{HS} )}{g} \qquad ( 14 )$$

where k is the thermal conductivity of the material (gas) in the gap evaluated in the direction of (or opposite of) heat conduction, T_{S} is the temperature of the photochromic glass surface and T_{HS} is the temperature of the heat sink surface (or the heat source surface, for other embodiments). As mentioned above, to evaluate k rigorously would require integrating the thermal conductivity of the gas along (or against) the direction of conductive heat flow, as the thermal conductivity of the gas varies with temperature—but as a good approximation, k may be taken as the value of k for the gas in the gap when at the average of the temperatures of the two surfaces, T_{S} and T_{HS}.

Reframing equation (14) in units of heat transfer coefficient (units of heat flow power per meter squared per degree Kelvin) gives:

$$\frac{{Q}_{cond}}{{A}_{g} ( {T}_{S} - {T}_{HS} )} = \frac{k}{g} \qquad ( 15 )$$

so the effective heat transfer coefficient for conduction across the gap is the thermal conductivity of the medium in the gap (air in this case) (in units of W/m·K) divided by the length of the gap (in meters), giving a value of Watts per meter squared per degree of temperature difference. Table V shows the heat transfer coefficients (k/g), due to conduction alone, for air and helium filled gaps of gap sizes from 10 μm up to 200 μm in steps of 10 μm each.

TABLE V

| Air | | | Helium | | |
|---|---|---|---|---|---|
| conductivity (W/m/K) | | 0.047 | conductivity (W/m/K) | | 0.253 |
| | heat trans coeff. | | | heat trans coeff. | |
| Gap (m) | W/m²/K | cal/s/cm² | Gap (m) | W/m²/K | cal/s/cm² |
| 0.00001 | 4700 | 0.11226 | 0.00001 | 25300 | 0.604291 |
| 0.00002 | 2350 | 0.05613 | 0.00002 | 12650 | 0.302145 |
| 0.00003 | 1566.67 | 0.03742 | 0.00003 | 8433.33 | 0.20143 |
| 0.00004 | 1175 | 0.028065 | 0.00004 | 6325 | 0.151073 |
| 0.00005 | 940 | 0.022452 | 0.00005 | 5060 | 0.120858 |
| 0.00006 | 783.333 | 0.01871 | 0.00006 | 4216.67 | 0.100715 |
| 0.00007 | 671.429 | 0.016037 | 0.00007 | 3614.29 | 0.086327 |
| 0.00008 | 587.5 | 0.014032 | 0.00008 | 3162.5 | 0.075536 |
| 0.00009 | 522.222 | 0.012473 | 0.00009 | 2811.11 | 0.067143 |
| 0.0001 | 470 | 0.011226 | 0.0001 | 2530 | 0.060429 |
| 0.00011 | 427.273 | 0.010205 | 0.00011 | 2300 | 0.054936 |
| 0.00012 | 391.667 | 0.009355 | 0.00012 | 2108.33 | 0.050358 |
| 0.00013 | 361.538 | 0.008635 | 0.00013 | 1946.15 | 0.046484 |
| 0.00014 | 335.714 | 0.008019 | 0.00014 | 1807.14 | 0.043164 |
| 0.00015 | 313.333 | 0.007484 | 0.00015 | 1686.67 | 0.040286 |
| 0.00016 | 293.75 | 0.007016 | 0.00016 | 1581.25 | 0.037768 |
| 0.00017 | 276.471 | 0.006604 | 0.00017 | 1488.24 | 0.035547 |
| 0.00018 | 261.111 | 0.006237 | 0.00018 | 1405.56 | 0.033572 |
| 0.00019 | 247.368 | 0.005908 | 0.00019 | 1331.58 | 0.031805 |
| 0.0002 | 235 | 0.005613 | 0.0002 | 1265 | 0.030215 |

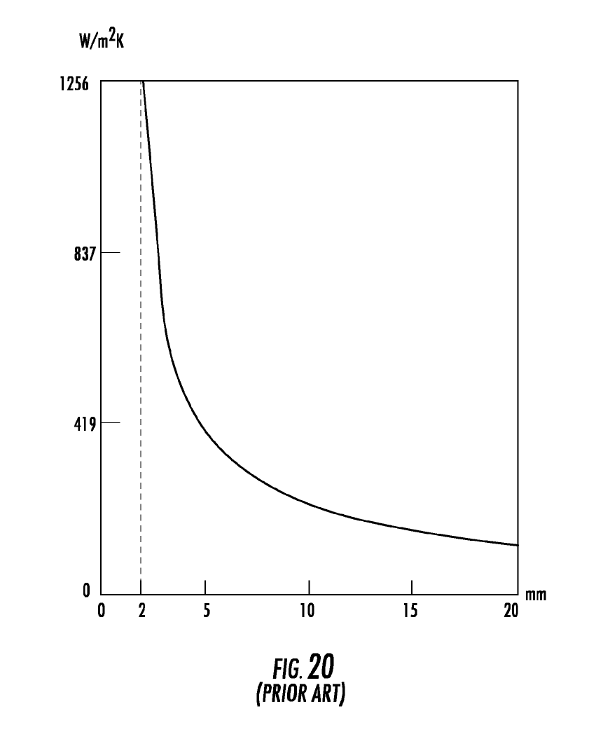

FIG. 20 (Prior Art) shows an industry-standard curve from about 35 years ago (with a dashed reference line at 2 mm added) showing the heat transfer coefficient required to fully temper a sheet of glass, as a function of thickness in mm, under certain assumed conditions. As may be seen from a comparison of Table V with FIG. 20, an air-filled gap of approximately 40 μm can allow full tempering of 2 mm thick photochromic glass by conduction. While slightly less than 40 micrometers is a rather small gap, planar porous air bearings in conveyor applications may generally be reliably run with gaps of as low as 20 micrometers. Thus 37 micrometers is achievable for an air gap fed by pores in the heat sink surface. Using helium (or hydrogen, with similar thermal conductivity) as the gas, a gap of about 200 μm can be used to fully temper 2 mm thick photochromic glass. Using helium or hydrogen as the gas allows for a gap size about 5 times larger for the same heat transfer coefficient. In other words, using helium or hydrogen as the gas in the gap increases the heat transfer coefficient available for quenching by about 5 times at the same gap size. So even with air the spacing is not impractical, and with high conductivity gases, the gap spacing is relatively easy to achieve, even for sheet thicknesses smaller than 2 millimeters.

In addition to cooling through a gas by conduction more than by convection, another embodiment includes heating (or heating and/or cooling) through a gas by conduction more than by convection. Regarding the relative contributions of conduction and convection, whether for heating or cooling, the convective Q_{conv}, component of the rate of heat transfer across the gap (or gaps) may be given by:

$${Q}_{conv} = e \dot{m} {C}_{p} ( \frac{{T}_{S} + {T}_{HS}}{2} - {T}_{i} ) \qquad ( 16 )$$

where \dot{m} is the mass flow rate of the gas, Cp is the specific heat capacity of the gas, Tᵢ is the inlet temperature of the gas as it flows into the gap, and e is the effectiveness of the heat exchange between the gas flowing in the gap, the sheet surface and the surface of the heat sink/source (the “walls” of the gap). The value of e varies from 0 (representing zero surface-to-gas heat exchange) to 1 (representing the gas fully reaching the temperature of the surfaces). The value of e can be computed by those skilled in the art of heat transfer using, for example, the e-NTU method.

Typically, however, if the gap between the surface of the sheet and the surface of the heat sink/source is small, the value of e will be very nearly equal to 1, meaning the gas heats nearly completely—to equal, on average, the average of the temperatures of the two surfaces on either side—before it leaves the gap. Assuming e=1 (a slight overestimate of the rate of convective heat transfer), and the gas being supplied to the gap through the surface of the heat sink/source, it can be assumed that the initial temperature of the gas in the gap is the same as the temperature of the surface of the heat sink/source (Tᵢ=T_{HS}). The rate of heat transfer due to convection may then be simplified to:

$${Q}_{conv} = \dot{m} {C}_{p} ( \frac{{T}_{S} - {T}_{HS}}{2} ) \qquad ( 17 )$$

At the temperatures typically useful for heat strengthening or heat treating of photochromic glass and similar materials, radiative heat transfer out of the sheet under treatment is relatively small. To cool (or heat, assuming the amount of radiation from the heat source when heating is not too high) the sheet (e.g., sheet 200 shown in FIG. 21) principally by conduction, in the area of the gap (e.g., gaps 204a, 204b shown in FIG. 21), thus requires only that:

Q_{cond}>Q_{conv} (18)

Combining (18) with equations (14) and (17) gives the following conditional:

$$\frac{k}{g} > \frac{\dot{m} {C}_{p}}{2 {A}_{g}} \qquad ( 19 )$$

which, when held, will essentially ensure that the sheet, in the area of the gap at issue, is cooled (or heated) principally by conduction. Accordingly, the mass flow rate \dot{m} of the gas should be less than 2kA_{g}/gCₚ, or 2k/gCₚ per square meter of gap area. In an embodiment, \dot{m}<B·(2kA_{g}/gCₚ), where B is the ratio of convective cooling to conductive cooling. As used herein, B is a positive constant less than one and greater than zero, specifically having a value of ⅔ or less, or even ⅘ or 9/10 or less. Generally, \dot{m} should be kept as low as possible, consistent with the needs of using the gas flow to control the position of the photochromic glass sheet (e.g., sheet 200 shown in FIG. 21 relative to the heat sink surface(s)) (e.g., heat sink surfaces 201b, 202b, shown in FIG. 21) or the position of the heat exchange surfaces themselves. The ratio of convective cooling to conductive cooling can be any value from less than one to 1×10⁻⁸. In some embodiments, B is less than 0.9, 0.8, 0.7, 0.6, 0.5, 0.4, 0.1, 5×10⁻², 1×10⁻², 5×10⁻³, 1×10⁻³, 5×10⁻⁴, 1×10⁻⁴, 5×10⁻⁵, 1×10⁻⁵, 5×10⁻⁶, 1×10⁻⁶, 5×10⁻⁷, 1×10⁻⁷, 5×10⁻⁸, or 1×10⁻⁸. In some embodiments, \dot{m} is minimized, consistent with the needs of using the gas flow to support and control the sheet position relative to the heat sink surface(s). In other embodiments, m should be selected to control the position of the heat exchange surfaces themselves, relative to the sheet.

In various embodiments, the mass flow rate m of the gas within the conductive-based cooling system of the present disclosure is substantially lower as compared to the conventional convection-based tempering systems. This substantially lower gas flow rate allows the conductive system to be operated at substantially reduced power usage, as discussed herein. Further, in at least some embodiments, the reduced gas flow rate also results in a substantially quieter cooling system as compared to a conventional convective cooling system. In such embodiments, the decrease in noise may increase operator safety by reducing the potential for hearing damage and even reducing or eliminating the need for operators to use hearing protection.

As will be understood, in embodiments in which a sheet of photochromic glass material is supported on air bearings between opposing heat sink surfaces, conductive heat transfer will occur from both sides of the photochromic glass sheet to both heat sink surfaces Thus, in such embodiments, the photochromic glass sheet has first and second sheet surfaces, and cooling of the photochromic glass sheet is performed by positioning the first sheet surface (e.g., a lower surface of the photochromic glass sheet) adjacent to a first heat sink surface (e.g., a surface of a lower heat sink) such that a first gap is located between the first sheet surface and the first heat sink surface and by positioning the second sheet surface (e.g., an upper surface of the photochromic glass sheet) adjacent to a second heat sink surface (e.g., a surface of an upper heat sink) such that a second gap is located between the second sheet surface and the second heat sink surface. In such embodiments, thermal conduction from the first sheet surface to the first heat sink surface and from the second sheet surface to the second heat sink surface is permitted to occur. In such embodiments, the first gap has a length across the first gap of g₁ and an area of the first gap of A_{g1}, and the second gap has a length across the second gap of g₂ and an area of the second gap of A_{g2}. In such embodiments, a first flow of a first gas to the first gap is provided, and a second flow of a second gas to the second gap is provided. As will be understood, similar to the discussion above, the first gas has a heat capacity Cₚ₁ and a thermal conductivity k₁, and the first flow is provided at a mass flow rate \dot{m}₁. In such embodiments, \dot{m}₁ is greater than zero and less than (2k₁A_{g1})/(g₁Cₚ₁). Further, the second gas has a heat capacity Cₚ₂ and a thermal conductivity k₂, and the second flow is provided at a mass flow rate \dot{m}₂. In such embodiments, \dot{m}₂ is greater than zero and less than (2k₂A_{g2})/(g₂Cₚ₂). In such embodiments, the first and second flows contact the photochromic glass sheet such that the photochromic glass sheet is supported without touching the heat sink surfaces. In this manner, the sheet is cooled by conduction more than by convection in a manner to create a surface compressive stress and a central tension of the sheet.

### Photochromic Glass Strengthening System Including High Conduction Cooling Zone

Referring to FIG. 21, a diagrammatic cross-section of a high conduction glass cooling/quenching station and of a glass sheet being cooled by conduction more than by convection is shown. A hot glass sheet 200 has its first and second (major) surfaces 200a, 200b each facing a respective first and second surface 201b, 202b of respective first and second heat sinks 201a, 202a across respective gaps 204a and 204b. Gas 230 is fed through the first and second surfaces 201b, 202b as represented by the arrows, to supply the gaps 204a, 204b, and to assist in keeping the photochromic glass sheet centered or otherwise positioned between the heat sinks 201a, 202a. The air or other gas may leave passing by the edges of the heat sinks 201a, 202a as shown by arrows 240. By choosing the size of the gaps 204a, 204b and the gas and the flow rate of the gas 230 in accordance with the discussion herein, the photochromic glass sheet 200 will be cooled more by conduction than convection. In specific embodiments, photochromic glass sheet 200 is cooled by heat sinks 201a and 202a such that more than 20%, specifically more than 50%, and more specifically more than 80%, of the thermal energy leaving a heated article, such as photochromic glass sheet 200, crosses the gaps, such as gaps 204a and 204b, and is received by the heat sink 201a and 202a.

In some embodiments, the gaps 204a, 204b are configured to have a thickness or distance across the gap sufficient such that the heated photochromic glass sheet is cooled by conduction more than by convention. As will be understood, size of gaps 204a, 204b generally is the distance between the major photochromic glass surfaces and the opposing heat sink surfaces.

In some embodiments, gaps 204a and 204b may have a thicknesses of about (e.g., plus or minus 1%) 100 μm or greater (e.g., in the ranges from about 100 μm to about 200 μm, from about 100 μm to about 190 from about 100 μm to about 180 μm, from about 100 μm to about 170 μm, from about 100 μm to about 160 μm, from about 100 μm to about 150 μm, from about 110 μm to about 200 μm, from about 120 μm to about 200 μm, from about 130 μm to about 200 μm, or from about 140 μm to about 200 μm). In other embodiments, gaps 204a and 204b may have a thicknesses of about (e.g., plus or minus 1%) 100 μm or less (e.g., in the ranges from about 10 μm to about 100 μm, from about 20 μm to about 100 μm, from about 30 μm to about 100 μm, from about 40 μm to about 100 μm, from about 10 μm to about 90 μm, from about 10 μm to about 80 μm, from about 10 μm to about 70 μm, from about 10 μm to about 60 μm, or from about 10 μm to about 50 μm).

Heat sinks 201a, 202a may be solid or porous configurations. Suitable materials include, but are not limited to, aluminum, bronze, carbon or graphite, stainless steel, etc. Heat sink dimensions may be designed to be sufficient to address the size of the photochromic glass sheet and to efficiently and effectively transfer heat without changing the heat sink temperature significantly. In the case where heat sinks 201a and/or 202a are porous, they may still include additional apertures or holes for flowing gas or may use the porous structure to provide flow, or both. In some embodiments, the heat sinks further comprise passages to allow fluid flow for controlling the temperature of the heat sink, described in more detail in FIGS. 23-25 and below.

Eliminating high gas flow rates of the prior art may enable use of very small apertures or pores 206, as shown in FIG. 21, in the heat sink face to provide the gas to the gap(s). In some embodiments, apertures may be less than 2 mm, less than 1.5 mm, less than 1 mm, less than 0.5 mm, less than 0.25 mm, or less than or equal to 200, 150, 100, 50, 30, 20, or 10 μm, when measured in the smallest direction (e.g., diameter in the case of circular apertures). In some embodiments, the apertures are from about (e.g., plus or minus 1%) 10 μm to about 1 mm, about 20 μm to about 1 mm, or about 50 μm to about 1 mm.

Spacing between adjacent apertures 206 can be from about (e.g., plus or minus 1%) 10 μm to about 3 mm, about 20 μm to about 2 mm, or about 50 μm to about 1 mm, measured edge-to-edge of apertures. Small apertures or pores may function as individual flow restrictors, providing high-performance, gas-bearing-type dynamics, such as high levels of stiffness and consistency of support of the sheet to position the sheet and control gap size, allowing for high homogeneity of thermal strengthening effects to avoid or reduce stress birefringence. Further, because very small pores or apertures may be used, the relative amount of solid matter at the surface of the heat sink facing the sheet surface across the gap(s) can be maximized, thereby increasing conductive heat flow.

According to various embodiments, use of such apertures 206 as the only path for providing gas to the gaps 204a, 204b, and desirably using apertures 206 that lie in directions close to normal to the heat sink surface 201b, 202b, ensures that air-bearing type dynamics are optimized, and not compromised by gas flows from larger apertures, or from sources other than through the heat sink surface(s) 201b, 202b adjacent to the sheet 200, or by other excessive lateral flow. In other embodiments gas may be provided to the gaps 204a, 204b via other sources, such as in addition to the apertures 206 or pores. Accordingly, aspects of the present disclosure allow for power and energy savings by use of low gas flows and solid-gas-solid conduction, such as relative to conventional convective tempering processes.

FIGS. 22-25 show an exemplary embodiment of a photochromic glass strengthening system 300 according to this disclosure. FIG. 22 shows a schematic cross-sectional diagram of the system 300, in which a photochromic glass sheet can be heated via conduction of heat from a gas bearing, through a gas into the photochromic glass sheet, and/or cooled via conduction of heat from the photochromic glass sheet, through a gas into a conductive heat sink. The apparatus includes a hot zone 310, a cold zone 330, and a transition gas bearing 320. Transition gas bearing 320 moves or directs a photochromic glass article (e.g., photochromic glass sheet 400a) from the hot zone 310 to the cold zone 330 such that no contact or substantially no contact occurs between the photochromic glass and the bearings. The hot zone 310 has gas bearings 312 each fed from a hot zone plenum 318, and the bearings 312 have cartridge heaters 314 inserted into holes through the bearings 312, which serve to heat the hot zone gas bearings 312 to a desired starting process temperature. A photochromic glass sheet (hot zone) 400a is kept between the hot zone gas bearings 312 for a duration long enough to bring it to a desired pre-cooling temperature (e.g., above the transition temperature).

In some embodiments, heating the sheet in the hot zone may be done predominantly via conduction of heat from a heat sink through a thin gas barrier. The conductive heating processes used in the hot zone can be similar to, but the reverse of the cooling processes described herein (e.g., pushing heat into the photochromic glass sheet). Large pieces of photochromic glass sheet can be thermally processed in the system 300. For example, but not limited to, pieces of photochromic glass sheet having a width or a length that is greater than 0.5 meters, greater than 1.0 meters or greater than 2.0 meters can be heated and/or cooled with the system 300 as disclosed herein.

In some embodiments, gaps 316, between the an outer surface of the hot zone gas bearings 312 and the photochromic glass sheet 400a surface, may be relatively large, on the order of 0.05″ (1.27 mm) to 0.125″ (3.175 mm) or greater, since the photochromic glass sheet 400a may be heated up relatively slowly and thermal radiation from the hot gas bearings 312 into the photochromic glass sheet 400a is adequate for this purpose. In other embodiments, hot zone gap size may be as small as 150 microns per side, 200 microns per side, 300 microns per side, 400 microns per side or 500 microns per side. Smaller gaps may be advantageous, in some embodiments, because they enable the bearings to have better “stiffness”—i.e., ability to centralize the photochromic glass and therefore flatten it while it is in its softened state. In some embodiments, the process may re-form the photochromic glass sheets—flattening them—in the initial heating step, for example via the pressure supplied by the gas bearings 312. Smaller gaps may also be advantageous for heating the photochromic glass sheet 400a with a thickness of greater than 0.7 mm, 1.1 mm or 2.0 mm, to a temperature above 500° C., 550° C. or 600° C. in less than or equal to 3 minutes, less than or equal to 2 minutes or less than equal to 1 minute without distortion of the photochromic glass sheet 400a. Such short heating times (flash heating) still provide desired photochromic properties and are advantageous with respect to reduced energy consumption, reduced production times, etc., during the production of photochromic glass sheet. In some embodiments, the top and bottom hot zone bearings may be on actuators, allowing for changing the gap width in a continuous manner or, alternatively, allowing the photochromic glass to be brought into the hot zone when the gap is large and then compressing or reducing the gap to flatten the photochromic glass while it is still soft.

Process temperatures are dependent on a number of factors, including photochromic glass composition, photochromic glass thickness, photochromic glass properties (CTE, etc.), and desired level of strengthening. Generally, the starting process temperature may be any value between the photochromic glass transition temperature and the Littleton softening point, or in some embodiments, even higher. For example, system 300 heats the photochromic glass sheet 400a to a temperature between about (e.g., plus or minus 1%) 640 to about 730° C. or between about 690 to about 730° C. In some embodiments, system 300 heats the photochromic glass sheet 400a to a temperature from about (e.g., plus or minus 1%) 620 to about 800° C., about 640 to about 770° C., about 660 to about 750° C., about 680 to about 750° C., about 690 to about 740° C., or about 690 to about 730° C. In other embodiments, system 300 heats the photochromic glass sheet 400a to a temperature from about 450 to about 850° C.

The photochromic glass sheet 400a is heated to its desired starting process temperature (e.g., above 450° C., 500° C., 550° C., 600° C., 650° C., 700° C., 750° C., 800° C. or 850° C. and below the photochromic glass softening temperature), and it is then moved from the hot zone 310 to the cold zone 330 using any suitable means. The photochromic glass can be heated to its desired starting process temperature in a short time period, e.g. in less than or equal to 3 minutes, less than or equal to 2 minutes, or less than or equal to 1 minute. In some embodiments, moving the photochromic glass sheet 400a from the hot zone 310 to the cold zone 330 may be accomplished by, for example (1) tilting the entire assembly such that gravity acting on the photochromic glass sheet forces it to move to the cold zone, (2) blocking off the gas flow from the leftmost exit of the hot zone 310 (the sides are enclosed in this embodiment), thereby forcing all of the gas emanating from all of the gas bearings to exit from the rightmost exit of the cold zone, causing fluid forces to be exerted on the photochromic glass sheet 400a and causing it to move to the cold zone 330, or (3) by a combination of (1) and (2)).

The transition gas bearings 320 may be supplied with gas by transition bearing plenums 328. The solid material thickness behind the surfaces of the transition gas bearings 320 may be thin, of low thermal mass and/or low thermal conductivity, allowing for reduced heat conduction from the hot zone 310 to the cold zone 330. The transition gas bearings 320 may serve as a thermal break or transition between the two zones 310 and 330 and may serve to transition from the larger gaps 316 of the hot zone down to small gaps 336 of the cold zone 330. Further, the low thermal mass and/or low thermal conductivity of transition gas bearings 320 limit(s) the amount of heat transfer and therefore cooling experienced by photochromic glass sheet 400a while passing past transition gas bearings 320.

Once the photochromic glass sheet (cold zone) 400b moves into the cold zone 330 and into the channel 330a, it is stopped from exiting the right side exit by a mechanical stop or any other suitable blocking mechanism, shown as stop gate 341. Once the photochromic glass sheet 400b cools sufficiently that the center has passed the photochromic glass transition (in the case, for example, of 1 mm thick photochromic glass, to below about 490° C., corresponding in this example to about 340° C. at the surface with a temperature difference between the center and the surface of about 150° C.), the stop gate 341 may be moved, unblocking cold zone channel 330a, and then the photochromic glass sheet 400b may be removed from the system 300. If desired, the photochromic glass sheet 400b may be left in the cold zone 330 until somewhere near room temperature before removal.

As noted above, within hot zone 310, photochromic glass sheet 400 is heated to a temperature above the photochromic glass transition temperature of the photochromic glass sheet. In the embodiment shown in FIG. 22, the cold zone 330 includes a channel 330a for receiving heated photochromic glass sheet 400b through an opening 330b, conveying the photochromic glass sheet 400b, and cooling the photochromic glass sheet 400b in the cold zone. In one or more embodiments, the channel 330a includes a conveyance system that may include gas bearings, roller wheels, conveyor belt, or other means to physically transport the photochromic glass sheet through the cold zone. As shown in FIG. 22, cold zone 330 includes gas bearings 332 which are fed plenums 338 that are separate from hot zone plenums 318 and transition plenums 328.

As shown in FIG. 22, the cold zone 330 includes one or more heat sinks 331 disposed adjacent to the channel 330a. Where two heat sinks are utilized, such heat sinks may be disposed on opposite sides of the channel 330a, facing each other across a channel gap 330a. In some embodiments, the heat sinks include a plurality of apertures 331a which form part of the gas bearing 332, and the surfaces of the cold gas bearings 332 of the cold zone 330 serve as the two heat sink surfaces. Due to the low air flow rate within channel 330a and the small size of channel gap 330a, photochromic glass sheet 400b is cooled within cold zone 330 primarily by conduction of heat from the photochromic glass sheet across the gap and into the solid heat sinks 331, without the photochromic glass sheet 400b touching the heat sink surfaces.

In some embodiments, the heat sinks and/or the surfaces thereof may be segmented. As noted above, in some embodiments, the heat sinks may be porous, and in such embodiments, the apertures through which the gas for gas bearings 332 is delivered are the pores of the porous heat sinks. The plurality of apertures 332b, a gas source and the channel gap 330a may be in fluid communication. In some embodiments, the gas flows through the apertures 331a to form gas cushions, layers or bearings in the channel gap 330a. The gas cushions of some embodiments prevent the photochromic glass sheet 400b from contacting the heat sink 331 surfaces. The gas also serves as the gas through which the photochromic glass sheet 400b is cooled by conduction more than by convection.

Because cooling occurs essentially by solid-to-solid heat conduction across the gaps, issues not present in convection-dominated cooling may need to be addressed. For example, for tempering of a large, thin sheet, the sheet may be (1) introduced quickly into the cold zone, optionally at higher speeds than those typically used in convection-based quenching and/or (2) the process is operated in a quasi-continuous mode, in which multiple sheets are heated and cooled one after the other in a continuous stream with little space between them, and where the heat sink is actively cooled such that it reaches a thermal equilibrium so that the front and trailing edges of the large sheets have similar thermal history.

In some embodiments, the gas flow through the apertures 331a cools the heat sinks. In some embodiments, the gas flow through the apertures both facilitates heat conduction, from the photochromic glass, across the gap, into the heat sinks, and also cools the heat sinks 331. In some instances, a separate gas or fluid may be used to cool the heat sinks 331. For instance, the heat sinks 331 may include passages 334, for flowing a cooling fluid therethrough to cool the heat sinks 331, as is more fully described with respect to FIG. 23. The passages 334 can be enclosed.

Where two heat sinks are used (i.e., a first heat sink and a second heat sink), one or more gas sources may be used to provide a gas to the channel gap 330a. The gas sources may include the same gas as one another or different gases. The channel gap 330a may, therefore, include one gas, a mixture of gases from different gas sources, or the same gas source. Exemplary gases include air, nitrogen, carbon dioxide, helium or other noble gases, hydrogen and various combinations thereof. The gas may be described by its thermal conductivity when it enters the channel 330a just before it begins to conductively cool the photochromic glass sheet 400b. In some instances, the gas may have a thermal conductivity of about (e.g., plus or minus 1%) 0.02 W/(m·K) or greater, about 0.025 W/(m·K) or greater, about 0.03 W/(m·K) or greater, about 0.035 W/(m·K) or greater, about 0.04 W/(m·K) or greater, about 0.045 W/(m·K) or greater, about 0.05 W/(m·K) or greater, about 0.06 W/(m·K) or greater, about 0.07 W/(m·K) or greater, about 0.08 W/(m·K) or greater, about 0.09 W/(m·K) or greater, about 0.1 W/(m·K) or greater, about 0.15 W/(m·K) or greater, or about 0.2 W/(m·K) or greater).

The processes and systems described herein allow for high heat transfer rates which, as discussed above, allow for a strengthening degree of temperature differential to form within even a very thin photochromic glass sheet. Using air as the gas, with gaps between the photochromic glass sheet and the heat sinks, heat transfer rates as high as 350, 450, 550, 650, 750, 1000, and 1200 kW/m² or more are possible through conduction alone. Using helium or hydrogen, heat transfer rates of 5000 kW/m² or more can be achieved.

The heat sinks 331 of one or more embodiments may be stationary or may be movable to modify the thickness of the channel gap 330a. The thickness of the photochromic glass sheet 400b may be in a range from about 0.4 times the thickness to about 0.6 times the thickness of channel gap 300a, which is defined as the distance between the opposing surfaces of the heat sinks 331 (e.g., upper and lower surface of heat sinks 331 in the arrangement of FIG. 22). In some instances, the channel gap is configured to have a thickness sufficient such that the heated photochromic glass sheet is cooled by conduction more than by convection.

In some embodiments, the channel gap may have a thickness such that when photochromic glass sheet 400b is being conveyed through or located within the channel 330a, the distance between the major surfaces of the photochromic glass sheet 400b and the heat sink surface (e.g., the gap size discussed above) is about (e.g., plus or minus 1%) 100 μm or greater (e.g., in the range from about 100 μm to about 200 μm, from about 100 μm to about 190 μm, from about 100 μm to about 180 μm, from about 100 μm to about 170 μm, from about 100 μm to about 160 μm, from about 100 μm to about 150 μm, from about 110 μm to about 200 μm, from about 120 μm to about 200 μm, from about 130 μm to about 200 μm, or from about 140 μm to about 200 μm). In some embodiments, the channel gap may have a thickness such that when photochromic glass sheet 400b is being conveyed through the channel, the distance between the photochromic glass sheet and the heat sink surface (the gap or gaps 336) is about (e.g., plus or minus 1%) 100 μm or less (e.g., in the range from about 10 μm to about 100 μm, from about 20 μm to about 100 μm, from about 30 μm to about 100 μm, from about 40 μm to about 100 μm, from about 10 μm to about 90 μm, from about 10 μm to about 80 μm, from about 10 μm to about 70 μm, from about 10 μm to about 60 μm, or from about 10 μm to about 50 μm). The total thickness of the channel gap 330a is dependent on the thickness of the photochromic glass sheet 400b, but can be generally characterized as 2 times the distance between the heat sink surface and the photochromic glass sheet, plus the thickness of the photochromic glass sheet. In some embodiments, the distance or gaps 336 between the photochromic glass sheet and the heat sinks may not be equal. In such embodiments, the total thickness of the channel gap 330a may be characterized as the sum of the distances between the photochromic glass sheet and each heat sink surface, plus the thickness of the photochromic glass sheet.

In some instances, the total thickness of the channel gap may be less than about (e.g., plus or minus 1%) 2500 μm (e.g., in the range from about 120 μm to about 2500 μm, about 150 μm to about 2500 μm, about 200 μm to about 2500 μm, about 300 μm to about 2500 μm, about 400 μm to about 2500 μm, about 500 μm to about 2500 μm, about 600 μm to about 2500 μm, about 700 μm to about 2500 μm, about 800 μm to about 2500 μm, about 900 μm to about 2500 μm, about 1000 μm to about 2500 μm, about 120 μm to about 2250 μm, about 120 μm to about 2000 μm, about 120 μm to about 1800 μm, about 120 μm to about 1600 μm, about 120 μm to about 1500 μm, about 120 μm to about 1400 μm, about 120 μm to about 1300 μm, about 120 μm to about 1200 μm, or about 120 μm to about 1000 μm). In some instances, the total thickness of the channel gap may be about 2500 μm or more (e.g., in the range from about 2500 μm to about 10,000 μm, about 2500 μm to about 9,000 μm, about 2500 μm to about 8,000 μm, about 2500 μm to about 7,000 μm, about 2500 μm to about 6,000 μm, about 2500 μm to about 5,000 μm, about 2500 μm to about 4,000 μm, about 2750 μm to about 10,000 μm, about 3000 μm to about 10,000 μm, about 3500 μm to about 10,000 μm, about 4000 μm to about 10,000 μm, about 4500 μm to about 10,000 μm, or about 5000 μm to about 10,000 μm).

The apertures 331a in the heat sink 331 may be positioned to be perpendicular to the heat sink surface or may be positioned at an angle of 20 degrees or less, such as about (e.g., plus or minus 1%) 15 degrees or less, about 10 degrees or less or about 5 degrees or less) from perpendicular to the heat sink surface.

In some embodiments, the material behind the heat sink (cold bearing 332) surfaces can be any suitable material having high heat transfer rates, including metals (e.g., stainless steel, copper, aluminum), ceramics, carbon, etc. This material may be relatively thick compared to the material behind the surfaces of the transition bearings 320, as shown in FIG. 22, such that heat sink can easily accept relatively large amounts of thermal energy. In an exemplary embodiment, the material of the heat sinks 331 is stainless steel.

FIG. 23 is a cut-away perspective cross-section of an apparatus similar to that of FIG. 22, albeit reversed from right to left, and comprising additionally a load/unload zone 340, next to cold zone 330 of system 300, including a load/unload gas bearing 342 with a photochromic glass sheet 400c positioned thereon. Also, the apparatus of FIG. 23 uses tight channel gaps (not indicated on the figure) in hot zone 310, transition bearing 320, and cold zone 330.

The inset in FIG. 23 shows an alternative embodiment of a cold zone gas bearing 332a, in which the gas bearing 322a is actively cooled by coolant channels 334, between gas bearing feed holes 333, where the feed holes feed the apertures in the surface of the gas bearing 322a. The cooling channels 334 are defined between heat sink segments 333b, which are assembled together to form the heat sink 331 and the surface thereof facing the photochromic glass sheet 400b.

The cooling channels 334 may be positioned very near the surface of the heat sink 331, in the solid material of the gas bearing 332, with a region of solid bearing material between the heat sink/gas bearing surface and the nearest-the-surface edge of the coolant channel 334, having the same width as the nearest-the-surface edge of the coolant channel 334. Accordingly, in some embodiments there is no region of reduced cross section in the solid material of the heat sink 331/gas bearing 332a between a coolant channel 334 and the surface facing the photochromic glass 400b. This differs from the typical convective gas cooling equipment, because the high gas flow rates mandate that significant space be provided in the middle of the array of gas nozzles for the gas flows to escape. Where active cooling is used, heat sink 331/gas bearing 332a has a region of reduced cross section in the solid material of the gas nozzle design, relative to the solid material nearest the photochromic glass surface. The reduced cross section region is generally positioned between the active cooling fluid and photochromic glass sheet under treatment, in order to give a high-volume path for the large volume of heated gas returning from the sheet.

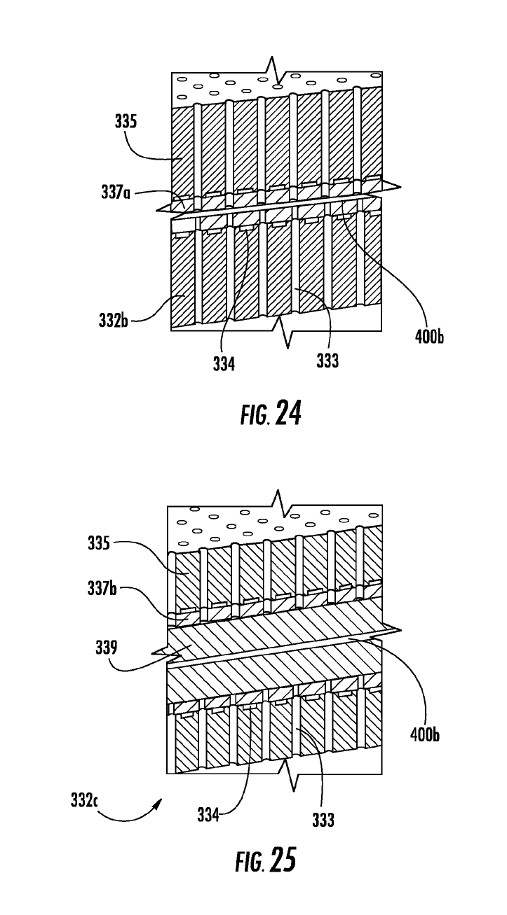

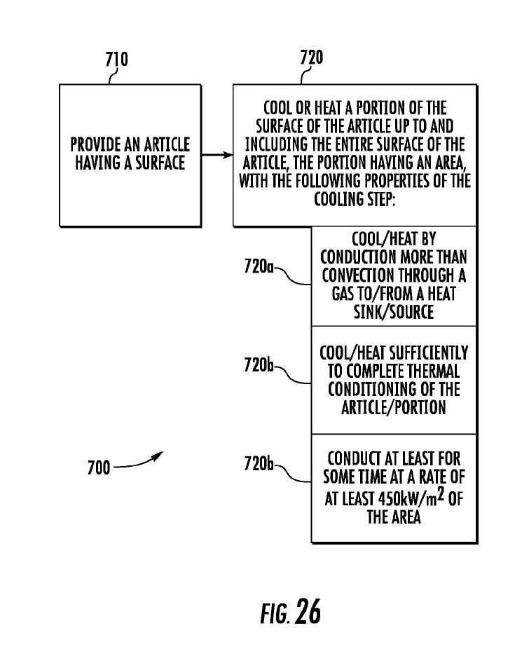

FIG. 24 shows yet another alternative embodiment of a cold zone gas bearing 332b, like that of the inset of FIG. 23. In this embodiment, coolant channels 334 are formed between a gas bearing feed member 335, containing gas bearing feed holes 333, and a gas bearing face member 337a, which provides the photochromic glass sheet 400b facing surface of the gas bearing 332. FIG. 25 shows yet another alternative cold zone gas bearing 332c having a similar structure to the embodiment of FIG. 24, but having a porous member 339 between a bearing plate member 337b and photochromic glass sheet 400b, such that porous member 339 forms the surface facing the photochromic glass sheet 400b.

It should be understood that in various embodiments, the photochromic glass strengthening processes and systems described herein in relation to FIGS. 16-26 may be used or operated to form a photochromic glass article (such as photochromic glass sheet 500) having any combination of features, characteristics, dimensions, physical properties, etc. of any of the photochromic glass article embodiments discussed herein.

Photochromic glass sheets having undergone the thermal strengthening processes described herein may be further processed by undergoing ion exchange to further enhance their strength. Ion-exchanging the surface of photochromic glasses heat strengthened as described herein may increase the above-described compressive stresses by at least 20 MPa, such as at least 50 MPa, such as at least 70 MPa, such as at least 80 MPa, such as at least 100 MPa, such as at least 150 MPa, such as at least 200 MPa, such as at least 300 MPa, such as at least 400 MPa, such as at least 500 MPa, such as at least 600 MPa and/or no more than 1 GPa, in some such contemplated embodiments.

### Systems and Processes for Thermal Conditioning and/or Heating Photochromic Glass Sheet

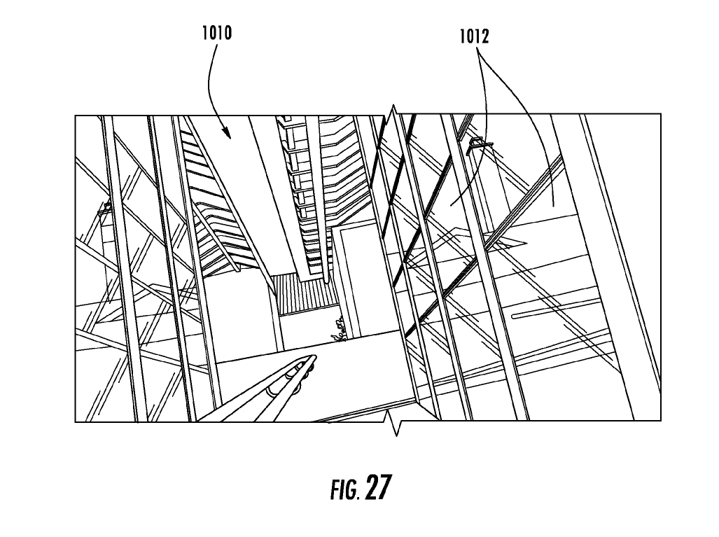

In addition to thermally strengthening thin photochromic glass sheets, the processes and systems described herein can be used for additional thermal conditioning processes as well. While cooling is specifically discussed herein, the systems and processes can be used to transfer heat into the photochromic glass sheet via a conductive method. Accordingly, additional embodiments of the processes of the current disclosure, including heating through a gas by conduction more than convection. Such a process or method 700 is illustrated in the flow chart of FIG. 26.

The method 700 includes two main steps. The first step, step 710, involves providing an article, such as a photochromic glass sheet, having at least one surface. The second step, step 720, involves heating or cooling a portion of the surface of the article, up to and including the entire surface of the article. Step 720 is performed by conduction more than by convection through a gas from or to a heat source or a heat sink source as shown in sub-part 720a, and is performed sufficiently to complete thermal conditioning and/or photochromic processing (e.g. precipitation of silver halide crystals within the photochromic glass) of the article or the portion of the surface of the article in sub-part 720b, and the conduction of the cooling/heating of step 720 is performed at a high rate of heat transfer, at least 450 kW/m² of the area of the portion in sub-part 720b.

For example, an article can be thermally conditioned and/or photochromic processed—i.e., either heated or cooled—by cooling or heating a portion of the surface of the article, up to and including the entire surface of the article (the portion having an area), by conduction more than by convection, the conduction mediated through a gas to or from a heat sink or a heat source and not through solid-to-solid contact, sufficiently to complete a thermal conditioning and/or photochromic processing of the article or of the portion of the surface of the article, and the conduction being performed, during at least some time of the heating or cooling, at a rate of at least 450, 550, 650, 750, 800, 900, 1000, 1100, 1200, 1500, 2000, 3000, 4000 or even 5000 or more kW per square meter.

In addition to tempering, the high rates of thermal power transfer provided by the systems and methods discussed herein allow for thermal processing or conditioning of all kinds, including heating and cooling during tempering, edge strengthening of photochromic glass. Additionally, since the heat is extracted or delivered primarily by conduction, tight control is provided over the thermal history and the heat distribution in the treated article while preserving surface smoothness and quality. Accordingly, in yet another aspect of the present disclosure, tight control is provided over the thermal history and the heat distribution in the treated article, since the heat is extracted or delivered primarily by conduction, yet surface smoothness and quality are preserved. Accordingly, it will be possible to use the systems and methods of the present disclosure to intentionally vary the stress profile and/or silver halide crystal density from the strengthening process and/or photochromic processing, both in the thickness direction and in the directions in which the plane of the sheet lies, by varying gaps, varying heat sink/source materials, varying heat sink/source temperatures, varying the gas mixture—and all these may be varied by position along the path of the sheet as it moves, or across the path of the sheet, or potentially in time also, not merely with position (for most of the variables).

### Devices, Products and Structures Incorporating Strengthened Photochromic Glass Sheets

The strengthened photochromic glass articles and sheets discussed herein have a wide range of uses in a wide range of articles, devices, products, structures, etc.

Referring to FIG. 27, a structure 1010, such as a building, house, vehicle, etc., includes a photochromic glass article 1012 in the form of a window, portion of walls (e.g., surfaces), dividers, etc. In contemplated embodiments, the photochromic glass article 1012 may be strengthened such that the photochromic glass article 1012 has a negative tensile stress on or near surfaces thereof, balanced by a positive tensile stress internal thereto, as disclosed herein. Further, the photochromic glass article 1012 may have a composition that resists chemicals and/or corrosion as may be present in outdoor environments by having a relatively high silicon dioxide content, such as at least 70% silicon dioxide by weight, such as at least 75% by weight. According to an exemplary embodiment, the photochromic glass article 1012 has major surfaces orthogonal to a thickness thereof (see generally sheet 500 as shown in FIG. 4), where the major surfaces have a large area (e.g., at least 5 cm², at least 9 cm², at least 15 cm², at least 50 cm², at least 250 cm²) relative to photochromic glass articles used in other applications (e.g., lenses, battery components, etc.). In contemplated embodiments, total light transmission through the photochromic glass articles 1012 is at least about 50% (e.g., at least 65%, at least 75%) from wavelengths of about 300 nm to about 800 nm, when the photochromic glass 1012 has thicknesses as disclosed herein, such as a thickness of less than 5 cm, less than 3 cm, less than 2 cm, less than 1.75 cm, less than 1.5 cm, less than 1 cm, less than 5 mm, less than 3 mm, less than 2 mm, less than 1.75 mm, less than 1.5 mm, less than 1 mm, less than 0.8 mm, less than 0.6 mm, less than 0.5 mm, less than 0.4 mm, less than 0.2 mm, and/or at least 10 micrometers, such as at least 50 micrometers.

Thin thicknesses of the photochromic glass article 1012 may not harm the function of the photochromic glass article 1012 in architectural, automotive, or other applications relative to conventional articles because the high level of strength of the photochromic glass article 1012 provided by the inventive processes disclosed herein. Thin photochromic glass articles 1012 may be particularly useful in such architectural, automotive, or other applications because the photochromic glass article 1012 may be lighter than conventional such articles, reducing the weight of the corresponding overall structure. For automobiles, a result may be greater fuel efficiency. For buildings, a result may be sturdier or less resource-intensive structures. In other contemplated embodiments, photochromic glass articles disclosed herein may have areas of lesser magnitude, greater thicknesses, transmit less light, and/or may be used in different applications, such as those disclosed with regard to FIGS. 27-28, for example.

Referring now to FIG. 28, a photochromic glass article 1310, manufactured according to processes disclosed herein and/or with any combination of stress profiles, structures and/or physical properties as disclosed herein, has curvature and/or a variable cross-sectional dimension D. Such articles may have thicknesses disclosed herein as an average of dimension D or as a maximum value of dimension D. While the glass article 1310 is shown as a curved sheet, other shapes, such as more complex shapes, may be strengthened by processes disclosed herein. In contemplated embodiments, the photochromic glass article 1310 may be used as a window for an automobile (e.g., sunroof), as a lens, as a container, or for other applications.

In various embodiments, photochromic glass material manufactured according to processes disclosed herein, and/or with any combination of stress profiles, structures and/or physical properties as disclosed herein, is useful to form at least one sheet of a photochromic glass-polymer-interlayer-glass laminate, such as used in many automotive glass sidelights. Stronger and thinner laminates can be produced, resulting in weight and cost savings and fuel efficiency increases. Desirably, a thermally strengthened thin sheet may be cold bent (see generally FIG. 28) and laminated to a formed thicker photochromic glass, providing an easy and reliable manufacturing process not requiring any hot forming/shaping of the thin sheet.

### Photochromic Glass for Thermally Strengthened Photochromic Glass Sheets

The systems and methods discussed may be used to thermally condition, strengthen, temper and/or photochromic process a wide variety of photochromic glass materials.

The processes and systems described herein may generally be used with almost any photochromic glass composition, and some embodiments can be used with photochromic glass laminates. In various embodiments, the processes can be used with photochromic glass compositions having high CTEs. In embodiments, photochromic glasses strengthened via the processes and systems discussed herein include alkali aluminosilicates, such as boroaluminosilicates, such as Corning's® Photogray®, Photobrown®, Photogray® Extra and Photobrown® Extra glasses and the like. In some embodiments, photochromic glasses strengthened via the processes and systems discussed herein have CTEs of greater than 40×10⁻⁷/° C., greater than 50×10⁻⁷/° C., greater than 60×10⁻⁷/° C., greater than 70×10⁻⁷/° C., greater than 80×10⁻⁷/° C., or greater than 90×10⁻⁷/° C.

In some applications and embodiments, photochromic glasses strengthened via the processes and systems discussed herein (such as photochromic glass sheet 500) may have a composition configured for chemical durability. In some such embodiments, the composition comprises at least 20% silicon dioxide by weight, and/or at least 5% sodium oxide by weight, and/or at least 7% % aluminum oxide by weight, and/or at least 10% boron oxide by weight. Conventional articles of such compositions may be difficult to chemically temper to a deep depth, and/or may be difficult, if not impossible, to thermally temper by conventional processes to a sufficient magnitude of negative surface tensile stress for thin thicknesses, such as due to fragility and forces of conventional processes. However, in contemplated embodiments, inventive processes disclosed herein allow a strengthened photochromic glass article or sheet, such as photochromic glass sheet 500, with such a composition, where negative tensile stress extends into the respective strengthened photochromic glass sheet to a distance of at least 10% of the thickness of the strengthened photochromic glass sheet from at least one of the first and second surfaces (e.g., surfaces 510, 520 of photochromic glass sheet 500), such as at least 12% of the thickness, 15% of the thickness, 18% of the thickness, 20% of the thickness.

In some embodiments, the photochromic glass sheets and articles strengthened as discussed herein have one or more coatings that are placed on the photochromic glass prior to the thermal strengthening and/or photochromic processing of the photochromic glass sheet. The processes discussed herein can be used to produce strengthened photochromic glass sheets having one or more coatings, and, in some such embodiments, the coating is placed on the photochromic glass prior to thermal strengthening and/or photochromic processing and is unaffected by the thermal strengthening and/or photochromic processing. Specific coatings that are advantageously preserved on photochromic glass sheets of the present disclosure include low E coatings, reflective coatings, antireflective coatings, anti-fingerprint coatings, cut-off filters, pyrolytic coatings, etc.

According to an exemplary embodiment, photochromic glass sheets or articles discussed herein, are boroaluminosilicate photochromic glasses. In some embodiments photochromic glass sheets or articles discussed herein, for example articles 1012 and 1310 shown in FIGS. 27 and 28, are generally boroaluminosilicate glasses, yet still have stress profiles and structures as disclosed herein. Such composition may reduce the degree of relaxation of the photochromic glass, facilitating coupling of transistors thereto. In some embodiments, the photochromic glass sheets/articles discussed herein are flexible photochromic glass sheets. In other embodiments, the photochromic glass sheets/articles discussed herein comprise a laminate of two or more photochromic glass sheets.

In some contemplated embodiments, photochromic glasses strengthened via the processes and systems discussed herein (such as photochromic glass sheet 500) may include an amorphous substrate. Photochromic glasses strengthened via the processes and systems discussed herein (such as photochromic glass sheet 500) may include alkali containing borosilicate photochromic glass. In one or more embodiments, photochromic glasses strengthened via the processes and systems discussed herein (such as photochromic glass sheet 500), in portions thereof not ion-exchanged, may include a photochromic glass having a composition, in mole percent (mol %), including: SiO₂ in the range from about (e.g., plus or minus 1%) 20 to about 65 mol %, Al₂O₃ in the range from about 5 to about 25 mol %, B₂O₃ in the range from about 010 to about 25 mol %, R₂O in the range from about 0 to about 20 mol %, RO in the range from about 0 to about 15 mol %, Ag in the range of about 0.1 to about 0.5 mol %, a halide in the range of about 0.1 to about 0.5 mol % and/or CuO in the range of about 0.001-0.05 mol %. In some contemplated embodiments, the composition may include either one or both of ZrO₂ in the range from about 0 to about 10 mol % and TiO₂ in the range from about 0 to about 5 mol %. In some contemplated embodiments, the composition may include NiO in the range from about 0 to about 0.5 mol % and/or Co₃O₄ in the range from about 0 to about 0.1 mol %.

In some contemplated embodiments, compositions used for the strengthened photochromic glass sheet or article discussed herein may be batched with 0-2 mol % of at least one fining agent selected from a group that includes Na₂SO₄, NaCl, NaF, NaBr, K₂SO₄, KCl, KF, KBr, and SnO₂. The photochromic glass composition according to one or more embodiments may further include SnO₂ in the range from about 0 to about 2 mol %, from about 0 to about 1 mol %, from about 0.1 to about 2 mol %, from about 0.1 to about 1 mol %, or from about 1 to about 2 mol %. Photochromic glass compositions disclosed herein for the strengthened photochromic glass sheet 500 may be substantially free of Pb, As₂O₃ and/or Sb₂O₃, in some embodiments.

In contemplated embodiments, the strengthened photochromic glass sheet or article discussed herein may include alkali boroaluminosilicate photochromic glass compositions that are further strengthened via an ion exchange process. One example photochromic glass composition comprises SiO₂, Al₂O₃ and B₂O₃, where (SiO₂+Al₂O₃)≥25 mol. %, and/or B₂O₃≥10 mol. %. In an embodiment, the photochromic glass composition includes at least 5 mol. % R₂O. In a further embodiment, the strengthened photochromic glass sheet or article discussed herein may include a photochromic glass composition with one or more alkaline earth oxides. Suitable photochromic glass compositions, in some embodiments, further comprise at least one of K₂O, MgO and CaO. In a particular embodiment, the photochromic glass compositions used in the strengthened photochromic glass sheet or article discussed herein can comprise an R₂O—Al₂O₃—B₂O₃—SiO₂ base composition containing silver and chloride and bromide contents as photochromic constituents and 0.27-0.38 wt. % NiO, 0.035-0.060 wt. % Co₃O₄ with a weight ratio of NiO:Co₃O₄ being at least 6:1.

A further example photochromic glass composition suitable for the strengthened photochromic glass sheet or article discussed herein comprises exclusive of photochromic constituents: 20-65 wt. % SiO₂; 5-25 wt. % Al₂O₃; 14-23 wt. % B₂O₃; 0-2.5 wt. % Li₂O; 0-9 wt. % Na₂O; 0-17 wt. % K₂O; 8-20 wt. % R₂O; 0-6 wt. % ZrO₂; and 0-3 wt. % TiO₂. The photochromic constituents include 0.15-0.3 wt. %; 0.1-0.25 wt. % Cl; 0.1-0.2 wt. % Br and 0.004-0.02 wt. % CuO. In particular contemplated embodiments, an boroaluminosilicate photochromic glass composition suitable for the strengthened photochromic glass sheet or article free of rare earth elements comprising in weight percent (wt %) based on oxides: 48≤SiO2≤58; 15≤B2O3≤21; 5≤Al2O3≤9; 2.5≤ZrO2≤6.5; 2≤Li2O≤4; 0≤Na2O≤3; 3≤K2O≤10; 0≤MgO≤2; 0≤CaO≤2; 0≤SrO≤2; 0≤BaO≤2; 0≤TiO2≤2.5; 2≤Nb2O5≤4.5; and a plurality of photochromic agents, comprising in weight percent (wt %) with respect to the glass matrix: 0.100≤Ag≤0.250; 0.200≤Cl≤0.500; 0.0100≤Br≤0.300; and 0.0050≤CuO≤0.0110.

A float-formable strengthened photochromic glass sheet or article may be characterized by smooth surfaces and consistent thickness, and is made by floating molten photochromic glass on a bed of molten metal, typically tin. In an example process, molten photochromic glass that is fed onto the surface of the molten tin bed forms a floating photochromic glass ribbon. As the photochromic glass ribbon flows along the tin bath, the temperature is gradually decreased until the photochromic glass ribbon solidifies into a solid photochromic glass article that can be lifted from the tin onto rollers. Once off the bath, the photochromic glass article can be cooled further and annealed to reduce internal stress.

Down-draw processes produce photochromic glass articles having a consistent thickness that possess relatively pristine surfaces. Because the average flexural strength of the photochromic glass article is controlled by the amount and size of surface flaws, a pristine surface that has had minimal contact has a higher initial strength. When this high strength photochromic glass article is then further strengthened (e.g., chemically), the resultant strength can be higher than that of a photochromic glass article with a surface that has been lapped and polished. Down-drawn photochromic glass articles may be drawn to a thickness of less than about 2 mm. In addition, down-drawn photochromic glass articles have a very flat, smooth surface that can be used in its final application without costly grinding and polishing.

The fusion draw process, for example, uses a drawing tank that has a channel for accepting molten photochromic glass raw material. The channel has weirs that are open at the top along the length of the channel on both sides of the channel. When the channel fills with molten material, the molten photochromic glass overflows the weirs. Due to gravity, the molten photochromic glass flows down the outside surfaces of the drawing tank as two flowing photochromic glass films. These outside surfaces of the drawing tank extend down and inwardly so that they join at an edge below the drawing tank. The two flowing photochromic glass films join at this edge to fuse and form a single flowing photochromic glass article. The fusion draw method offers the advantage that, because the two photochromic glass films flowing over the channel fuse together, neither of the outside surfaces of the resulting photochromic glass article comes in contact with any part of the apparatus. Thus, the surface properties of the fusion drawn photochromic glass article are not affected by such contact.

The slot draw process is distinct from the fusion draw method. In slot draw processes, the molten raw material photochromic glass is provided to a drawing tank. The bottom of the drawing tank has an open slot with a nozzle that extends the length of the slot. The molten photochromic glass flows through the slot/nozzle and is drawn downward as a continuous photochromic glass article and into an annealing region.

In some embodiments, the photochromic glass article may be formed using a thin rolling process, as described in U.S. Pat. No. 8,713,972, U.S. Pat. No. 9,003,835, U.S. Patent Publication No. 2015/0027169, and U.S. Patent Publication No. 20050099618, the contents of which are incorporated herein by reference in their entirety. More specifically the photochromic glass article may be formed by supplying a vertical stream of molten photochromic glass, forming the supplied stream of molten photochromic glass with a pair of forming rolls, maintained at a surface temperature of about 500° C. or higher or about 600° C. or higher, to form a formed photochromic glass ribbon having a formed thickness, sizing the formed ribbon of photochromic glass with a pair of sizing rolls, maintained at a surface temperature of about 400° C. or lower to produce a sized photochromic glass ribbon having a desired thickness less than the formed thickness and a desired thickness consistency. The apparatus used to form the photochromic glass ribbon may include a photochromic glass feed device for supplying a supplied stream of molten photochromic glass; a pair of forming rolls maintained at a surface temperature of about 500° C. or higher, the forming rolls being spaced closely adjacent each other, defining a photochromic glass forming gap between the forming rolls with the glass forming gap located vertically below the photochromic glass feed device for receiving the supplied stream of molten photochromic glass and thinning the supplied stream of molten photochromic glass between the forming rolls to form a formed photochromic glass ribbon having a formed thickness; and a pair of sizing rolls maintained at a surface temperature of about 400° C. or lower, the sizing rolls being spaced closely adjacent each other, defining a glass sizing gap between the sizing rolls with the glass sizing gap located vertically below the forming rolls for receiving the formed photochromic glass ribbon and thinning the formed photochromic glass ribbon to produce a sized photochromic glass ribbon having a desired thickness and a desired thickness consistency.

In some instances, the thin rolling process may be utilized where the viscosity of the photochromic glass does not permit use of fusion or slot draw methods. For example, thin rolling can be utilized to form the photochromic glass articles when the photochromic glass exhibits a liquidus viscosity less than 100 kP. The photochromic glass article may be acid polished or otherwise treated to remove or reduce the effect of surface flaws.

### Examples

Apparatus setup—As detailed above, the apparatus comprises three zones—a hot zone, a transition zone, and a cool or quench zone. The gaps between the top and bottom thermal bearings (heat sinks) in the hot zone and the quench zone are set to the desired spacings. Gas flow rates in the hot zone, transition zone, and quench zone are set to ensure centering of the photochromic glass material, sheet or part on the air-bearing. The hot zone is pre-heated to the desired T₀, the temperature from which the photochromic glass article will be subsequently quenched. To ensure uniform heating, photochromic glass articles are pre-heated in a separate pre-heating apparatus, such as a batch or continuous furnace. Generally, photochromic glass sheets are pre-heated for greater than 5 minutes prior to loading in the hot zone. After the pre-heat phase, the photochromic glass article is loaded into the hot zone and allowed to equilibrate, where equilibration is where the photochromic glass is uniformly at T₀. T₀ can be determined by the level of strengthening/tempering desired, but is generally kept in the range between the softening point and the glass transition temperature. The time to equilibration is dependent at least on the thickness of the photochromic glass. For example, for photochromic glass sheets of approximately 1.1 mm or less, equilibration occurs in approximately 10 seconds. For 3 mm photochromic glass sheets, equilibration occurs in approximately 10 seconds to 30 seconds. For thicker sheets, up to approximately 6 mm, the equilibration time may be on the order of 60 seconds. Once the photochromic glass has equilibrated to T₀, it is rapidly transferred through the transition zone on air bearings and into the cool or quench zone. The photochromic glass article rapidly quenches in the quench zone to a temperature below the glass transition temperature, Tg. The photochromic glass sheet can be maintained in the quench zone for any period of time from 1 second, 10 seconds, or to several minutes or more, depending on the degree of quench desired and/or the desired temperature of the photochromic glass at removal. Upon removal the photochromic glass is optionally allowed to cool before handling.

The following examples for soda-lime silicate glass, CORNING® GORILLA® Glass, Borofloat-33 glass, etc., are summarized in Table VI. It is appreciated that similar results are achieved for photochromic glasses.

### Example 1

A soda-lime silicate glass plate (e.g., glass comprising at least 70% silicon dioxide by weight, and/or at least 10% sodium oxide by weight, and/or at least 7% calcium oxide by weight) of 5.7 mm thickness is pre-heated for 10 minutes at 450° C. before transferring to the hot zone where it is held at a T₀ of 690° C. for 60 seconds. After equilibrating to T₀, it is rapidly transferred to the quench zone filled with helium, which has a gap of 91 μm (wherein the gap is the distance between the surface of the glass sheet and the nearest heat sink), where it is held for 10 seconds. The resulting article has a surface compression of −312 MPa, a central tension of 127 MPa, and a flatness of 83 μm.

### Example 2

A soda-lime silicate glass plate of 5.7 mm thickness is pre-heated for 10 minutes at 450° C. before transferring to the hot zone where it is held at a T₀ of 690° C. for 60 seconds. After equilibrating it is rapidly transferred to the quench zone, which has a gap of 91 μm, where it is held for 10 seconds. The resulting article has a surface compression of −317 MPa, a central tension of 133 MPa, and a flatness of about 89.7 micrometers.

### Example 3

A soda-lime silicate glass plate of 1.1 mm thickness is pre-heated for 10 minutes at 450° C. before transferring to the hot zone where it is held at a T₀ of 700° C. for 10 seconds. After equilibrating it is rapidly transferred to the quench zone filled with helium, which has a gap of 56 μm, where it is held for 10 seconds. The resulting article has a surface fictive temperature measured to be 661° C., a surface compression of −176 MPa, a central tension of 89 MPa, a flatness of 190 μm, and a Vicker's cracking threshold of 10-20 N.

### Example 4

A soda-lime silicate glass plate of 0.55 mm thickness is pre-heated for 10 minutes at 450° C. before transferring to the hot zone where it is held at a T₀ of 720° C. for 10 seconds. After equilibrating it is rapidly transferred to the quench zone, which has a gap of 25 μm, where it is held for 10 seconds, resulting in an effective heat transfer rate of 0.184 cal/(cm²-s-° C.). The resulting article has a surface compression of −176 MPa and a central tension of 63 MPa. Also, the resulting strengthened articles had a flatness of about 168 (for the initial 710° C. temperature sample) and 125 micrometers (for the initial 720° C. temperature sample).

### Example 5

A CORNING® GORILLA® Glass plate of 1.5 mm thickness is pre-heated for 10 minutes at 550° C. before transferring to the hot zone where it is held at a T₀ of 790° C. for 30 seconds. After equilibrating it is rapidly transferred to the quench zone, which has a gap of 226 μm, where it is held for 10 seconds. The glass article has an improvement in flatness measured to be 113 μm pre-processing and 58 μm post-processing.

### Example 6

A soda-lime silicate glass plate of 0.7 mm thickness is pre-heated for 10 minutes at 450° C. before transferring to the hot zone where it is held at a T₀ of 730° C. for 10 seconds. After equilibrating it is rapidly transferred to the quench zone filled with helium, which has a gap of 31 μm, where it is held for 10 seconds, resulting in an effective heat transfer rate of 0.149 cal/(cm²-s-° C.). The resulting article has a surface compression of −206 MPa, a central tension of 100 MPa, and a flatness of 82 μm. Upon fracture, the glass sheet is observed to “dice” (using standard terminology for 2 mm thickness or greater sheet dicing—i.e., a 5×5 cm square of glass sheet breaks into 40 or more pieces) suggesting that the sheet is fully tempered.

### Example 7

A Borofloat-33 glass plate of 3.3 mm thickness is pre-heated for 10 minutes at 550° C. before transferring to the hot zone where it is held at a T₀ of 800° C. for 30 seconds. After equilibrating it is rapidly transferred to the quench zone, which has a gap of 119 μm, where it is held for 10 seconds. The resulting article has a flatness of 120 μm. Upon fracture of the part it is observed to “dice” (using standard terminology for 2 mm or greater thickness sheet dicing—i.e., a 5×5 cm square of glass sheet breaks into 40 or more pieces) showing that the sheet is fully tempered.

### Example 8

A soda-lime silicate glass plate of 3.2 mm thickness is pre-heated for 10 minutes at 450° C. before transferring to the hot zone where it is held at a T₀ of 690° C. for 30 seconds. After equilibrating it is rapidly transferred to the quench zone, which has a gap of 84 μm, where it is held for 10 seconds. The resulting article has a surface compression of −218 MPa, a central tension of 105 MPa, and a flatness of 84 μm.

### Example 9

A soda-lime silicate glass plate of 0.3 mm thickness is pre-heated for 10 minutes at 450° C. before transferring to the hot zone where it is held at a T₀ of 630° C. for 10 seconds. After equilibrating it is rapidly transferred to the quench zone, which has a gap of 159 μm, where it is held for 10 seconds. The resulting article has membrane stresses which are observable by gray field polarimetry, suggesting the glass has incorporated the thermal stress.

### Example 10

A CORNING® GORILLA® Glass plate of 0.1 mm thickness is pre-heated for 10 minutes at 550° C. before transferring to the hot zone where it is held at a T₀ of 820° C. for 10 seconds. After equilibrating it is rapidly transferred to the quench zone, which has a gap of 141 μm, where it is held for 10 seconds, resulting in an effective heat transfer rate of 0.033 cal/(cm²-s-° C.) Upon fracture, the resulting article displays behavior consistent with a residually stressed glass.

### Example 11

A soda-lime silicate glass plate of 1.1 mm thickness is pre-heated for 10 minutes at 450° C. before transferring to the hot zone where it is held at a T₀ of 700° C. for 10 seconds. After equilibrating it is rapidly transferred to the quench zone, which has a gap of 65 μm, where it is held for 10 seconds, resulting in an effective heat transfer rate of 0.07 cal/(cm²-s-° C.). The resulting article has a surface fictive temperature measured to be 657° C., a surface compression of −201 MPa, a central tension of 98 MPa, a flatness of 158 μm, and a Vicker's cracking threshold of 10-20 N.

### Example 12

A CORNING® GORILLA® Glass plate of 1.1 mm thickness is pre-heated for 10 minutes at 550° C. before transferring to the hot zone where it is held at a T₀ of 810° C. for 10 seconds. After equilibrating it is rapidly transferred to the quench zone which has a gap of 86 μm, where it is held for 10 seconds, resulting in an effective heat transfer rate of 0.058 cal/(cm²-s-° C.). The resulting article has a surface fictive temperature measured to be 711° C., a surface compression of −201 MPa, a central tension of 67 MPa, and a Vicker's cracking threshold of 20-30N.

### Example 13

A CORNING® GORILLA® Glass plate of 1.1 mm thickness is pre-heated for 10 minutes at 550° C. before transferring to the hot zone where it is held at a T₀ of 800° C. for 10 seconds. After equilibrating it is rapidly transferred to the quench zone, which has a gap of 91 μm, where it is held for 10 seconds. The resulting article has a surface fictive temperature measured to be 747° C., a surface compression of −138 MPa, a central tension of 53 MPa, a flatness of 66 μm, and a Vicker's cracking threshold of 20-30 N.

TABLE VI

| | Thickness | | Gaps | | | CS | CT | Flatmaster | Fictive | Vickers |
|---|---|---|---|---|---|---|---|---|---|---|
| Example | (mm) | Composition | (um) | T₀ | Gas | (MPa) | (MPa) | (um) | (° C.) | (N) |
| 1 | 5.7 | SLG | 91 | 690 | Helium | −312 | 127 | 83 | — | — |
| 2 | 5.7 | SLG | 91 | 690 | Helium | −317 | 133 | 90 | — | — |
| 3 | 1.1 | SLG | 56 | 700 | Helium | −176 | 89 | 190 | 661.3 | 10-20 |
| 4 | 0.55 | SLG | 25 | 720 | Helium | −176 | 63 | 125 | — | — |
| 5 | 1.5 | GG | 226 | 790 | Helium | — | — | 113 before/ | — | — |
| | | | | | | | | 58 after | | |
| 6 | 0.7 | SLG | 31 | 730 | Helium | −206 | 100 | 82 | — | — |
| 7 | 3.3 | Borofloat 33 | 119 | 800 | Helium | — | — | 121 | — | — |
| 8 | 3.2 | SLG | 84 | 690 | Helium | −218 | 105 | 81 | — | — |
| 9 | 0.3 | SLG | 159 | 630 | Helium | — | — | — | — | — |
| 10 | 0.1 | GG | 141 | 820 | Helium | — | — | — | — | — |
| 11 | 1.1 | SLG | 65 | 700 | Helium | −201 | 98 | 158 | 657 | 10-20 |
| 12 | 1.1 | GG | 86 | 810 | Helium | −201 | 67 | — | 711 | 20-30 |
| 13 | 1.1 | GG | 91 | 800 | Helium | −138 | 53 | 66 | 747 | 20-30 |

### Additional Example 1

a 5.7 mm thick sheet of glass comprising at least 70% silicon dioxide by weight, and/or at least 10% sodium oxide by weight, and/or at least 7% calcium oxide by weight was run with helium gas and gaps 204a, 204b (FIG. 21) of about 90 micrometers. The photochromic glass was heated to an initial temperature of about 690° C. and quickly cooled. The resulting strengthened article had a negative tensile stress of about 300 MPa on surfaces thereof and a positive tensile stress of about 121 MPa in the center. Also, the resulting strengthened article had a flatness of about 106.9 micrometers.

### Additional Example 2

In one experiment using inventive technology disclosed herein, a 1.1 mm thick sheet of glass comprising at least 70% silicon dioxide by weight, and/or at least 10% sodium oxide by weight, and/or at least 7% calcium oxide by weight was run with helium gas and gaps 204a, 204b (FIG. 21) of about 160 micrometers. The photochromic glass was heated to an initial temperature of about 680° C. and quickly cooled. The resulting strengthened article had a negative tensile stress of about 112 MPa on surfaces thereof and a positive tensile stress of about 54 MPa in the center. Prior to strengthening, the sheet of photochromic glass had a flatness of about 96 micrometers, but the resulting strengthened article had a flatness of about 60 micrometers. Accordingly, the strengthening process also flattened the strengthened photochromic glass article.

### Additional Example 3

a 2 mm thick sheet of glass comprising at least 70% silicon dioxide by weight, and/or at least 10% sodium oxide by weight, and/or at least 7% calcium oxide by weight was run with air in for heating and helium gas for quenching and (quenching) gaps 204a, 204b (FIG. 21) of about 300 micrometers. The photochromic glass was heated to an initial temperature of about 650° C., held at about 650° C. for about 2 minutes, then quickly cooled. The resulting strengthened article had an approximately parabolic stress profile with a negative tensile stress of about 93 MPa on surfaces thereof and a positive tensile stress of about 58 MPa in the center. The resulting photochromic sheet darkened to a transmittance of about 40% when exposed to a simulated sun spectrum for less than 5 minutes.

### Additional Example 4

a 2 mm thick sheet of glass comprising at least 70% silicon dioxide by weight, and/or at least 10% sodium oxide by weight, and/or at least 7% calcium oxide by weight was run with air in for heating and helium gas for quenching and (quenching) gaps 204a, 204b (FIG. 21) of about 300 micrometers. The photochromic glass was heated to an initial temperature of about 670° C., held at about 670° C. for about 2 minutes, then quickly cooled. The resulting strengthened article had an approximately parabolic stress profile with a negative tensile stress of about 75 MPa on surfaces thereof and a positive tensile stress of about 45 MPa in the center. The resulting photochromic sheet darkened to a transmittance of about 40% when exposed to a simulated sun spectrum for less than 5 minutes.

Other aspects and advantages will be apparent from a review of the specification as a whole and the appended claims.

The construction and arrangements of the photochromic glass, as shown in the various exemplary embodiments, are illustrative only. Although only a few embodiments have been described in detail in this disclosure, many modifications are possible (e.g., variations in sizes, dimensions, structures, shapes, and proportions of the various elements, values of parameters, mounting arrangements, use of materials, colors, orientations) without materially departing from the novel teachings and advantages of the subject matter described herein. Some elements shown as integrally formed may be constructed of multiple parts or elements, the position of elements may be reversed or otherwise varied, and the nature or number of discrete elements or positions may be altered or varied. The order or sequence of any process, logical algorithm, or method steps may be varied or re-sequenced according to alternative embodiments. Other substitutions, modifications, changes and omissions may also be made in the design, operating conditions and arrangement of the various exemplary embodiments without departing from the scope of the present inventive technology.

1. A process for making photochromic glass comprising:
heating an article formed from a glass material containing photochromic material above a glass transition temperature of the glass material and forming photochromic crystals in the glass material, the article supported with moving gas during the heating; and
cooling the heated article to a temperature below the glass transition temperature such that surface compressive stresses and central tensile stresses are created within the article, the cooled article being a reversibly photochromic glass material,
wherein the article is cooled by transferring thermal energy from the heated article to a heat sink by conduction across a gap between the heated article and the heat sink such that more than 20% of the thermal energy leaving the heated article crosses the gap and is received by the heat sink.

2. The process of claim 1, further comprising supporting the article with moving gas during cooling, wherein more than half of the thermal energy leaving the heated article crosses the gap and is received by the heat sink.

3. The process of claim 1, wherein the gap has an average length between an outer surface of the heated article and the heat sink surface that is less than 200 μm.

4. The process of claim 1, wherein a heat transfer rate from the article during cooling is greater than 450 kW/m² for the area of the outer surface of the article.

5. The process of claim 1, wherein during the heating step the article is heated to a temperature above 600° C. and below a softening point of the glass material within a time period of less than or equal to 3 minutes.

6. The process of claim 1, wherein the article is a glass sheet having a length, a width and a thickness, wherein the thickness is greater than 0.1 mm and less than 6 mm, and at least one of the width and the length are greater than 1 meter.

7. The process of claim 1, wherein the gas gap has a gap area, wherein a total mass flow rate of gas into the gas gap is greater than zero and less than 2k/gCp per square meter of gap area, where k is the thermal conductivity of a gas within the gas gap evaluated in the direction of heat conduction, g is the distance between the heated article and the heat sink surface, and Cp is the specific heat capacity of the gas within the gas gap.

8. The process of claim 1, wherein the photochromic crystals contain silver, a halide and copper.

9. A process for making photochromic glass comprising:
providing article formed from a glass material, the glass material containing photochromic material;
heating the article above a glass transition temperature of the glass material and forming photochromic crystals in the glass material, the article supported with moving gas during the heating; and
cooling the heated article to a temperature below the glass transition temperature such that surface compressive stresses and central tensile stresses are created within the article, the cooled article being a reversibly photochromic glass material,
wherein the article is heated by transferring thermal energy from a gas bearing to the article by conduction across a gap between the gas bearing and the article such that more than 20% of the thermal energy leaving the gas bearing crosses the gap and is received by the article.

10. The process of claim 9, further comprising supporting the article with moving gas during heating, wherein more than half of the thermal energy leaving the gas bearing crosses the gap and is received by the article.

11. The process of claim 9, wherein the gap has an average length between an outer surface of the gas bearing and the article that is less than 200 μm.

12. The process of claim 9, wherein a heat transfer rate from the gas bearing is greater than 450 kW/m² for the area of the outer surface of the article.

13. The process of claim 9, wherein during the heating step the article is heated to a temperature above 600° C. and below a softening point of the glass material within a time period of less than 2 minutes.

14. The process of claim 9, wherein the article is a glass sheet having a length, a width and a thickness, wherein the thickness is greater than 0.1 mm and less than 2 mm, and at least one of the length and the width are greater than 1 meter.

15. The process of claim 9, wherein the gas gap has a gap area, wherein a total mass flow rate of gas into the gas gap is greater than zero and less than 2k/gCp per square meter of gap area, where k is the thermal conductivity of a gas within the gas gap evaluated in the direction of heat conduction, g is the distance between the outer surface of the gas bearing and the article surface, and Cp is the specific heat capacity of the gas within the gas gap.

16. A system for making a photochromic glass sheet comprising:
a heating station including a heating element delivering heat to the photochromic glass sheet, the photochromic glass sheet including a first major surface, a second major surface and a thickness between the first and second major surfaces;
a cooling station including opposing first and second heat sink surfaces defining a channel therebetween such that during cooling the photochromic glass sheet is located within the channel; and
a gas bearing delivering pressurized gas to the channel such that the photochromic glass sheet is supported within the channel without touching the first and second heat sink surfaces, the gas bearing defining a gap area;
wherein the gas delivered by the gas bearing has a total mass flow rate into the channel that is greater than zero and less than 2k/gCₚ per square meter of gap area, where k is the thermal conductivity of a gas within the channel evaluated in the direction of heat conduction, g is the distance between the glass sheet and the heat sink surface, and Cₚ is the specific heat capacity of the gas within the channel.

17. The system of claim 16, further comprising a heated photochromic glass sheet within the cooling station, wherein the glass sheet has a thickness of less than 2 mm, wherein the first major surface faces the first heat sink surface and the second major surface faces the second heat sink surface, wherein an average distance between the first major surface and the first heat sink surface is less than 200 μm, and further wherein an average distance between the second major surface and the second heat sink surface is less than 200 μm.

18. The system of claim 16, wherein, within the cooling station, thermal energy from the glass sheet is transferred to the heat sink by conduction from the glass sheet to the heat sink, and the channel is sized such that more than half of the thermal energy leaving the glass sheet is received by the heat sink.

19. The system of claim 16, wherein the gas bearing comprises openings in the first and second heat sink surfaces, wherein the pressurized gas of the gas bearing is delivered through the openings.

20. The system of claim 16, wherein a perpendicular distance between opposing sections of the first and second heat sink surfaces is between 1.01 and 5 times the thickness of the glass sheet.

21. The system of claim 16, wherein, within the cooling station, thermal energy from the glass sheet is transferred to the heat sink by conduction from the glass sheet to the heat sink, and the channel is sized such that more than 20% of the thermal energy leaving the glass sheet is received by the heat sink.

22. The system of claim 16, wherein a heat transfer rate from the glass sheet during cooling is greater than 450 kW/m² for the surface area of the glass sheet.

23. A photochromic glass or glass ceramic article comprising:
a first major surface;
a second major surface opposite the first major surface;
an interior region located between the first and second major surfaces;
an average thickness between the first major surface and second major surface of less than 2 mm;
at least 50% silicon dioxide, 0.05 silver, 0.05 halide and 0.005 copper oxide by weight;
wherein silver halide crystals with an average diameter between 10-999 angstroms are present in the interior region;
wherein the first major surface and the second major surfaces are under compressive stress and the interior region is under tensile stress;
wherein the compressive stress is greater than 80 MPa;
wherein a surface roughness of the first major surface is less than less than 0.20 micrometer, peak-to-peak, per 20 mm of measurement length.
